(19) United States
(12) Patent Application Publication
(10) Pub. No.: US 2020/0057897 A1
(43) Pub. Date: Feb. 20, 2020

(54) OBSTACLE SENSING DEVICE

(71) Applicant: DENSO CORPORATION, Kariya-city (JP)

(72) Inventors: Mitsuyasu MATSUURA, Nisshin-city (JP); Taketo HARADA, Nisshin-city (JP); Yu MAEDA, Nisshin-city (JP); Hirohiko YANAGAWA, Kariya-city (JP)

(21) Appl. No.: 16/662,380

(22) Filed: Oct. 24, 2019

Related U.S. Application Data
(63) Continuation of application No. PCT/JP2018/010273, filed on Mar. 15, 2018.

(30) Foreign Application Priority Data
Apr. 28, 2017 (JP) 2017-089962

(51) Int. Cl. G06K 9/00; G06T 7/62; G06T 7/50; G01S 15/08; G01S 15/93; G01S 15/02

(52) U.S. Cl. CPC G06K 9/00805; G06T 7/62; G06T 7/50; G06T 2207/30261; G01S 15/931; G01S 15/025; G01S 15/08

(57) ABSTRACT

A position acquisition unit acquires relative position information between an own vehicle and an obstacle based on a reception wave received by a distance measurement sensor. A shape recognition unit executes shape recognition of the obstacle based on image information acquired by an image capturing unit. A detection processing unit detects the obstacle based on the relative position information acquired by the position acquisition unit and a shape recognition result obtained by the shape recognition unit. The detection processing unit determines whether the height of the obstacle is equal to or greater than a predetermined height or not. The detection processing unit discards the relative position information corresponding to the obstacle in a case where the shape recognition result obtained by the shape recognition unit indicates that the height of the obstacle is less than the predetermined height.

### CROSS-REFERENCE TO RELATED APPLICATION

The present application is a continuation application of International Application No. PCT/JP2018/010273, filed Mar. 15, 2018, which claims priority to Japanese Patent Application No. 2017-89962, filed Apr. 28, 2017. The contents of these applications are incorporated herein by reference in their entirety.

### BACKGROUND

### Technical Field

The present disclosure relates to an obstacle sensing device.

### Background Art

A device includes an object determination unit, and a sonar having an irradiation unit, a reception unit, and a position detection unit.

### SUMMARY

In the present disclosure, provided is an obstacle sensing device as the following. The obstacle sensing device includes at least one distance measurement sensor that is arranged to transmit a search wave toward the outside of the own vehicle and receive a reception wave containing a reflection wave produced by the search wave being reflected from the obstacle to output a signal corresponding to a distance to the obstacle; an image capturing unit that is arranged to acquire image information corresponding to an image of a periphery of the own vehicle; a vehicle state acquisition unit that is arranged to acquire traveling state information corresponding to a traveling state of the own vehicle; a position acquisition unit that is arranged to acquire, based on the output signal of the distance measurement sensor, relative position information corresponding to a relative position of the obstacle relative to the own vehicle; a shape recognition unit that is arranged to execute shape recognition of the obstacle based on the image information acquired by the image capturing unit and the traveling state information acquired by the vehicle state acquisition unit; and a detection processing unit that is arranged to detect the obstacle based on the relative position information acquired by the position acquisition unit and a shape recognition result obtained by the shape recognition unit, wherein the detection processing unit is configured to discard the relative position information corresponding to the obstacle in a case where the shape recognition result indicates that a height dimension of the obstacle is less than a predetermined dimension.

### BRIEF DESCRIPTION OF THE DRAWINGS

FIG. 1 is a plan view of a schematic configuration of an own vehicle equipped with an obstacle sensing device according to an embodiment.

FIG. 2 is a functional block diagram of a first embodiment of the obstacle sensing device illustrated in FIG. 1.

FIG. 3 is a schematic view for describing the schematic of operation of the obstacle sensing device illustrated in FIG. 2.

FIG. 4A is a schematic view for describing the schematic of operation of the obstacle sensing device illustrated in FIG. 2.

FIG. 4B is a schematic view for describing the schematic of operation of the obstacle sensing device illustrated in FIG. 2.

FIG. 5 is a flowchart of an operation example of the obstacle sensing device illustrated in FIG. 2.

FIG. 6 is a flowchart of an operation example of the obstacle sensing device illustrated in FIG. 2.

FIG. 7 is a schematic view for describing the schematic of operation of a second embodiment of the obstacle sensing device illustrated in FIG. 1.

FIG. 8 is a schematic view for describing the schematic of operation of the second embodiment of the obstacle sensing device illustrated in FIG. 1.

FIG. 9 is a schematic view for describing the schematic of operation of a third embodiment of the obstacle sensing device illustrated in FIG. 1.

FIG. 10 is a flowchart of an operation example of the third embodiment of the obstacle sensing device illustrated in FIG. 1.

FIG. 11 is a functional block diagram of a fourth embodiment of the obstacle sensing device illustrated in FIG. 1.

FIG. 12A is a schematic view for describing the schematic of operation of the obstacle sensing device illustrated in FIG. 11.

FIG. 12B is a schematic view for describing the schematic of operation of the obstacle sensing device illustrated in FIG. 11.

FIG. 12C is a schematic view for describing the schematic of operation of the obstacle sensing device illustrated in FIG. 11.

FIG. 13A is a schematic view for describing the schematic of operation of the obstacle sensing device illustrated in FIG. 11.

FIG. 13B is a schematic view for describing the schematic of operation of the obstacle sensing device illustrated in FIG. 11.

FIG. 14 is a flowchart of an operation example of the obstacle sensing device illustrated in FIG. 11.

FIG. 15 is a flowchart of an operation example of a fifth embodiment of the obstacle sensing device illustrated in FIG. 1.

FIG. 16 is a flowchart of an operation example of the fifth embodiment of the obstacle sensing device illustrated in FIG. 1.

FIG. 17 is a flowchart of an operation example of the fifth embodiment of the obstacle sensing device illustrated in FIG. 1.

### DETAILED DESCRIPTION OF THE PREFERRED EMBODIMENTS

The present disclosure relates to an obstacle sensing device mounted on an own vehicle to sense an obstacle present outside the own vehicle.

A device described in JP-A-2014-58247 includes an object determination unit, and a sonar having an irradiation unit, a reception unit, and a position detection unit. The sonar may be also referred to as a “distance measurement sensor.” The irradiation unit irradiates the outside of an own vehicle with an ultrasonic wave. The reception unit receives a reflection wave from an object. The position detection unit detects the position of the object based on round-trip time of the ultrasonic wave. The object determination unit determines characteristics regarding the height of the object from a change in a detection state of the object specified based on the reflection wave.

As described above, in the device of this type, a distance from the distance measurement sensor or the own vehicle equipped with the distance measurement sensor to an obstacle is acquired based on a reflection wave produced by a search wave being reflected from the obstacle. A reflection wave sensing result contains information corresponding to the distance between the distance measurement sensor and the object, and on the other hand, does not essentially contain information corresponding to the height of the object. Thus, the typical device of this type cannot accurately obtain the information regarding the height of the object.

Meanwhile, the reflection wave sensing result is susceptible to the height dimension of the obstacle. Thus, for the typical device of this type, there is still room for improvement in terms of obstacle sensing accuracy. That is, the obstacle as a sensing target might be, for example, an obstacle with a short protrusion height from a road surface, such as a curbstone. In this case, an unignorable error might occur between the acquired distance and an actual horizontal distance between the own vehicle and the obstacle.

The present disclosure has been made in view of, e.g., the situation described above by way of example.

According to one aspect of the present disclosure, an obstacle sensing device is mounted on an own vehicle to sense an obstacle present outside the own vehicle.

According to another aspect of the present disclosure, an obstacle sensing device is mounted on an own vehicle to sense an obstacle present outside the own vehicle.

The obstacle sensing device includes at least one distance measurement sensor that is arranged to transmit a search wave toward the outside of the own vehicle and receive a reception wave containing a reflection wave produced by the search wave being reflected from the obstacle to output a signal corresponding to a distance to the obstacle; an image capturing unit that is arranged to acquire image information corresponding to an image of a periphery of the own vehicle; a distance acquisition unit that is arranged to acquire distance information corresponding to the distance of the obstacle from the own vehicle based on the output signal of the distance measurement sensor; a shape recognition unit that is arranged to execute shape recognition of the obstacle based on the image information acquired by the image capturing unit; and a distance correction unit that is arranged to correct the distance information corresponding to the obstacle based on a mounting position of the distance measurement sensor in a vehicle height direction in a case where a shape recognition result obtained by the shape recognition unit indicates that a height dimension of the obstacle is less than a predetermined dimension.

Hereinafter, embodiments will be described with reference to the drawings. Note that various modifications applicable to a certain embodiment will not be inserted in the middle of a series of description regarding the embodiment, and will be collectively described after the series of description.

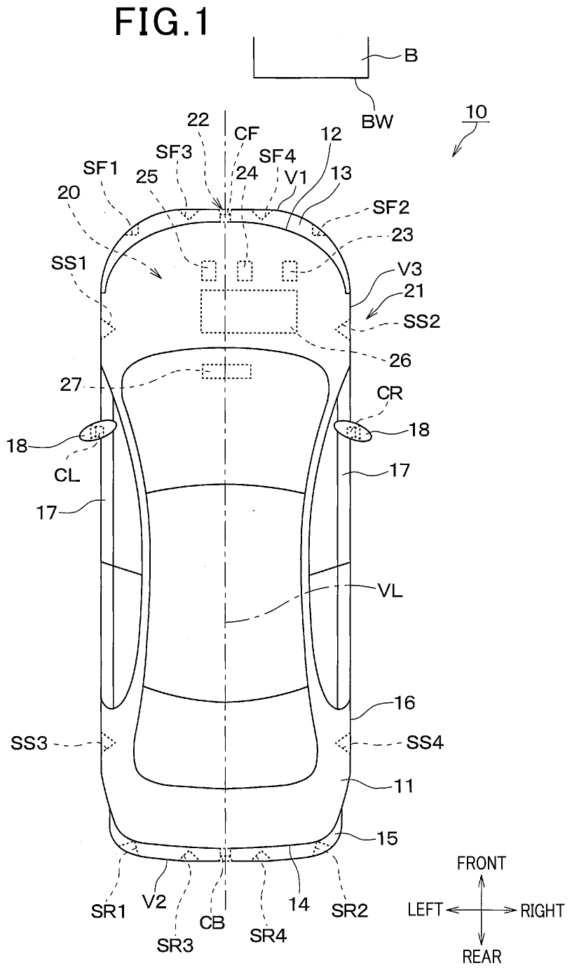

Referring to FIG. 1, a vehicle 10 is a so-called four-wheeled vehicle, and includes a substantially rectangular vehicle body 11 as viewed in plane. Hereinafter, a virtual line passing through the center of the vehicle 10 in a vehicle width direction thereof and extending parallel to a vehicle entire length direction of the vehicle 10 will be referred to as a vehicle center axis line VL. The vehicle entire length direction is a direction perpendicular to the vehicle width direction and perpendicular to a vehicle height direction. The vehicle height direction is a direction defining the height of the vehicle 10 and extending parallel to a direction in which gravity acts in a case where the vehicle 10 is mounted on a horizontal plane. In FIG. 1, the vehicle entire length direction is an front-to-rear direction in the figure, and the vehicle width direction is a right-to-left direction in the figure.

The “front,” “rear,” “right,” and “left” of the vehicle 10 are defined as indicated by arrows in FIG. 1. That is, the vehicle entire length direction is synonymous with a front-to-rear direction. Moreover, the vehicle width direction is synonymous with the right-to-left direction. Further, the vehicle height direction is synonymous with the up-to-down direction. Note that as described later, the vehicle height direction, i.e., the up-to-down direction, might not be parallel to the gravity acting direction depending on mounting conditions or traveling conditions of the vehicle 10 in some cases.

A front bumper 13 is attached to a front portion 12 as a front end portion of the vehicle body 11. A rear bumper 15 is attached to a rear portion 14 as a rear end portion of the vehicle body 11. Door panels 17 are attached to side portions 16 of the vehicle body 11. In a specific example illustrated in FIG. 1, two door panels 17 on each of the right and left sides, i.e., the total of four door panels 17, are provided. Door mirrors 18 are each attached to the right and left door panels 17 in a pair on the front side.

An obstacle sensing device 20 is mounted on the vehicle 10. The obstacle sensing device 20 is mounted on the vehicle 10 so that an obstacle B present outside the vehicle 10 can be sensed. Hereinafter, the vehicle 10 equipped with the obstacle sensing device 20 will be referred to as a “own vehicle 10.”

Specifically, the obstacle sensing device 20 includes a distance measurement sensor 21, an image capturing unit 22, a vehicle speed sensor 23, a shift position sensor 24, a steering angle sensor 25, a control unit 26, and a display 27. Hereinafter, details of each unit forming the obstacle sensing device 20 will be described. Note that for the sake of simplicity in illustration, an electric connection relationship among the units forming the obstacle sensing device 20 is not shown in FIG. 1.

The distance measurement sensor 21 is arranged to transmit a search wave toward the outside of the own vehicle 10 and receive a reception wave containing a reflection wave produced by a search wave being reflected on a wall surface BW of the obstacle B, thereby outputting a signal corresponding to a distance to the obstacle B. Specifically, in the present embodiment, the distance measurement sensor 21 is a so-called ultrasonic sensor, and is capable of transmitting the search wave i.e. an ultrasonic wave and receiving the reception wave containing the reflection wave.

The obstacle sensing device 20 includes at least one distance measurement sensor 21. Specifically, in the present embodiment, multiple distance measurement sensors 21 are attached to the vehicle body 11. Each of the multiple distance measurement sensors 21 is arranged shifted from the vehicle center axis line VL to one side in the vehicle width direction. Moreover, at least some of the multiple distance measurement sensors 21 are arranged to transmit the search wave along a direction crossing the vehicle center axis line VL.

Specifically, a first front sonar SF1, a second front sonar SF2, a third front sonar SF3, and a fourth front sonar SF4 as the distance measurement sensors 21 are attached to the front bumper 13. Similarly, a first rear sonar SR1, a second rear sonar SR2, a third rear sonar SR3, and a fourth rear sonar SR4 as the distance measurement sensors 21 are attached to the rear bumper 15.

Moreover, a first side sonar SS1, a second side sonar SS2, a third side sonar SS3, and a fourth side sonar SS4 as the distance measurement sensors 21 are attached to the side portions 16 of the vehicle body 11. Unless otherwise specified as any of the first front sonar SF1, the second front sonar SF2, the third front sonar SF3, the fourth front sonar SF4, the first rear sonar SR1, the second rear sonar SR2, the third rear sonar SR3, the fourth rear sonar SR4, the first side sonar SS1, the second side sonar SS2, the third side sonar SS3, and the fourth side sonar SS4, a singular term “distance measurement sensor 21” or a term “multiple distance measurement sensors 21” will be used below.

When a certain distance measurement sensor 21 is referred to as a “first distance measurement sensor” and another distance measurement sensor is referred to as a “second distance measurement sensor,” a “direct wave” and an “indirect wave” will be defined as follows. A reception wave that is received by the first distance measurement sensor and is caused by a reflection wave produced by the search wave transmitted from the first distance measurement sensor being reflected from the obstacle B, will be referred to as the “direct wave”. On the other hand, a reception wave that is received by the first distance measurement sensor and is caused by a reflection wave produced by the search wave transmitted from the second distance measurement sensor being reflected from the obstacle B, will be referred to as the “indirect wave”.

The first front sonar SF1 is provided at a left end portion of a front surface V1 of the front bumper 13 to transmit the search wave to the front left side of the own vehicle 10. The second front sonar SF2 is provided at a right end portion of the front surface V1 of the front bumper 13 to transmit the search wave to the front right side of the own vehicle 10. The first front sonar SF1 and the second front sonar SF2 are arranged symmetrically with respect to the vehicle center axis line VL.

The third front sonar SF3 and the fourth front sonar SF4 are arranged in the vehicle width direction at positions closer to the center of the front surface V1 of the front bumper 13. The third front sonar SF3 is arranged between the first front sonar SF1 and the vehicle center axis line VL in the vehicle width direction to transmit the search wave to the substantially front side of the own vehicle 10. The fourth front sonar SF4 is arranged between the second front sonar SF2 and the vehicle center axis line VL in the vehicle width direction to transmit the search wave to the substantially front side of the own vehicle 10. The third front sonar SF3 and the fourth front sonar SF4 are arranged symmetrically with respect to the vehicle center axis line VL.

As described above, the first front sonar SF1 and the third front sonar SF3 are arranged at different positions in plan view. Moreover, the first front sonar SF1 and the third front sonar SF3 are adjacent to each other in the vehicle width direction, and they are provided in such a positional relationship that the reflection wave produced by the search wave transmitted from any one of them being reflected from the obstacle B can be received as the reception wave for the other one of them.

That is, the first front sonar SF1 is arranged to receive both of the direct wave corresponding to the search wave transmitted from the first front sonar SF1 itself and the indirect wave corresponding to the search wave transmitted from the third front sonar SF3. Similarly, the third front sonar SF3 is arranged to receive both of the direct wave corresponding to the search wave transmitted from the third front sonar SF3 itself and the indirect wave corresponding to the search wave transmitted from the first front sonar SF1.

Similarly, the third front sonar SF3 and the fourth front sonar SF4 are arranged at different positions in plan view. Moreover, the third front sonar SF3 and the fourth front sonar SF4 are adjacent to each other in the vehicle width direction, and they are provided in such a positional relationship that the reflection wave produced by the search wave transmitted from any one of them being reflected from the obstacle B can be received as the reception wave for the other one of them.

Similarly, the second front sonar SF2 and the fourth front sonar SF4 are arranged at different positions in plan view. Moreover, the second front sonar SF2 and the fourth front sonar SF4 are adjacent to each other in the vehicle width direction, and they are provided in such a positional relationship that the reflection wave produced by the search wave transmitted from any one of them being reflected from the obstacle B can be received as the reception wave for the other one of them.

The first rear sonar SR1 is provided at a left end portion of a rear surface V2 of the rear bumper 15 to transmit the search wave to the rear left side of the own vehicle 10. The second rear sonar SR2 is provided at a right end portion of the rear surface V2 of the rear bumper 15 to transmit the search wave to the rear right side of the own vehicle 10. The first rear sonar SR1 and the second rear sonar SR2 are arranged symmetrically with respect to the vehicle center axis line VL.

The third rear sonar SR3 and the fourth rear sonar SR4 are arranged in the vehicle width direction at positions closer to the center of the rear surface V2 of the rear bumper 15. The third rear sonar SR3 is arranged between the first rear sonar SR1 and the vehicle center axis line VL in the vehicle width direction to transmit the search wave to the substantially rear side of the own vehicle 10. The fourth rear sonar SR4 is arranged between the second rear sonar SR2 and the vehicle center axis line VL in the vehicle width direction to transmit the search wave to the substantially rear side of the own vehicle 10. The third rear sonar SR3 and the fourth rear sonar SR4 are arranged symmetrically with respect to the vehicle center axis line VL.

As described above, the first rear sonar SR1 and the third rear sonar SR3 are arranged at different positions in plan view. Moreover, the first rear sonar SR1 and the third rear sonar SR3 are adjacent to each other in the vehicle width direction, and they are provided in such a positional relationship that the reflection wave being produced the search wave transmitted from any one of them being reflected from the obstacle B can be received as the reception wave for the other one of them.

That is, the first rear sonar SR1 is arranged to receive both of the direct wave corresponding to the search wave transmitted from the first rear sonar SR1 itself and the indirect wave corresponding to the search wave transmitted from the third rear sonar SR3. Similarly, the third rear sonar SR3 is arranged to receive both of the direct wave corresponding to the search wave transmitted from the third rear sonar SR3 itself and the indirect wave corresponding to the search wave transmitted from the first rear sonar SR1.

Similarly, the third rear sonar SR3 and the fourth rear sonar SR4 are arranged at different positions in plan view. Moreover, the third rear sonar SR3 and the fourth rear sonar SR4 are adjacent to each other in the vehicle width direction, and they are provided in such a positional relationship that the reflection wave produced by the search wave transmitted from any one of them being reflected from the obstacle B can be received as the reception wave for the other one of them.

Similarly, the second rear sonar SR2 and the fourth rear sonar SR4 are arranged at different positions in plan view. Moreover, the second rear sonar SR2 and the fourth rear sonar SR4 are adjacent to each other in the vehicle width direction, and they are provided in such a positional relationship that the reflection wave produced by the search wave transmitted from any one of them being reflected from the obstacle B can be received as the reception wave for the other one of them.

The first side sonar SS1, the second side sonar SS2, the third side sonar SS3, and the fourth side sonar SS4 are arranged to transmit the search waves from vehicle side surfaces V3 i.e. outer surfaces of the side portions 16 to the sides of the own vehicle 10. Each of the first side sonar SS1, the second side sonar SS2, the third side sonar SS3, and the fourth side sonar SS4 are arranged to receive only the direct wave.

The first side sonar SS1 is arranged between the left door mirror 18 and the first front sonar SF1 in the front-to-rear direction to transmit the search wave to the left side of the own vehicle 10. The second side sonar SS2 is arranged between the right door mirror 18 and the second front sonar SF2 in the front-to-rear direction to transmit the search wave to the right side of the own vehicle 10. The first side sonar SS1 and the second side sonar SS2 are provided symmetrically with respect to the vehicle center axis line VL.

The third side sonar SS3 is arranged between the rear left door panel 17 and the first rear sonar SR1 in the front-to-rear direction to transmit the search wave to the left side of the own vehicle 10. The fourth side sonar SS4 is arranged between the rear right door panel 17 and the second rear sonar SR2 in the front-to-rear direction to transmit the search wave to the right side of the own vehicle 10. The third side sonar SS3 and the fourth side sonar SS4 are provided symmetrically with respect to the vehicle center axis line VL.

Each of the multiple distance measurement sensors 21 is electrically connected to the control unit 26. That is, each of the multiple distance measurement sensors 21 transmits the search wave under control of the control unit 26, and generates a signal corresponding to a reception result of the reception wave to send the signal to the control unit 26. Information contained in the signal corresponding to the reception result of the reception wave will be hereinafter referred to as “reception information.” The reception information contains information relating to the reception intensity of the reception wave and information relating to a distance between each of the multiple distance measurement sensors 21 and the obstacle B. The information relating to the distance to the obstacle B contains information relating to a time difference from transmission of the search wave to reception of the reception wave.

The image capturing unit 22 is arranged to capture an image of the periphery of the own vehicle 10 to acquire image information corresponding to the image. In the present embodiment, the image capturing unit 22 is a digital camera device, and includes an image sensor such as a CCD. CCD stands for “charge coupled device”.

In the present embodiment, multiple image capturing units 22, i.e., a front camera CF, a rear camera CB, a left camera CL, and a right camera CR, are mounted on the own vehicle 10. Unless otherwise specified as any of the front camera CF, the rear camera CB, the left camera CL, and the right camera CR, a singular term “image capturing unit 22” or a term “multiple image capturing units 22” will be used below.

The front camera CF is attached to the front portion 12 of the vehicle body 11 to acquire the image information corresponding to an image of the front side of the own vehicle 10. The rear camera CB is attached to the rear portion 14 of the vehicle body 11 to acquire the image information corresponding to an image of the rear side of the own vehicle 10. The left camera CL is attached to the left door mirror 18 to acquire the image information corresponding to an image of the left side of the own vehicle 10. The right camera CR is attached to the right door mirror 18 to acquire the image information corresponding to an image of the right side of the own vehicle 10.

Each of the multiple image capturing units 22 is electrically connected to the control unit 26. That is, each of the multiple image capturing units 22 acquires the image information under control of the control unit 26, and transmits the acquired image information to the control unit 26.

The vehicle speed sensor 23, the shift position sensor 24, and the steering angle sensor 25 are electrically connected to the control unit 26. The vehicle speed sensor 23 is arranged to generate a signal corresponding to the traveling speed of the own vehicle 10 to transmit the signal to the control unit 26. The traveling speed of the own vehicle 10 will be hereinafter merely referred to as a “vehicle speed.” The shift position sensor 24 is arranged to generate a signal corresponding to the shift position of the own vehicle 10 to transmit the signal to the control unit 26. The steering angle sensor 25 is arranged to generate a signal corresponding to the steering angle of the own vehicle 10 to transmit the signal to the control unit 26.

The control unit 26 is arranged inside the vehicle body 11. The control unit 26 is a so-called in-vehicle microcomputer, and includes a not-shown CPU, a not-shown ROM, a not-shown RAM, a not-shown non-volatile RAM, etc. The non-volatile RAM is, for example, a flash ROM. The CPU, the ROM, the RAM, and the non-volatile RAM of the control unit 26 will be hereinafter merely abbreviated as a “CPU,” a “ROM,” a “RAM,” and a “non-volatile RAM.”

The control unit 26 is configured to implement various types of control operation in such a manner that the CPU reads a program from the ROM or the non-volatile RAM to execute the program. This program contains one corresponding to each of later-described routines. Moreover, in the ROM or the non-volatile RAM, various types of data used upon execution of the program are stored in advance. Various types of data include, for example, a initial value, a look-up table, and a map.

The control unit 26 is configured to execute obstacle sensing operation based on the signals and information received from, e.g., each of the multiple distance measurement sensors 21, each of the multiple image capturing units 22, the vehicle speed sensor 23, the shift position sensor 24, and the steering angle sensor 25. The display 27 is arranged inside a vehicle compartment of the own vehicle 10. The display 27 is electrically connected to the control unit 26 to perform display in association with the obstacle sensing operation under control of the control unit 26.

### First Embodiment

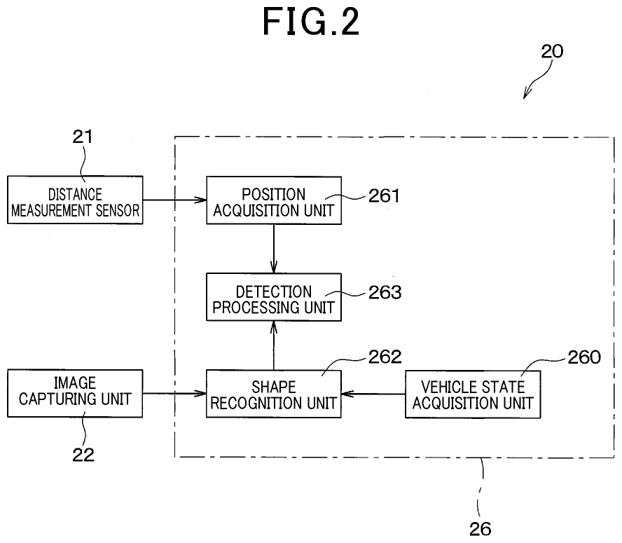

Next, functional block configurations of an obstacle sensing device 20 and a control unit 26 in a first embodiment will be described with reference to not only FIG. 1 but also FIG. 2. The control unit 26 is configured to detect an obstacle B based on a reception wave reception result by a distance measurement sensor 21, an image capturing result by an image capturing unit 22, and various signals received from various sensors such as a vehicle speed sensor 23. Specifically, as illustrated in FIG. 2, the control unit 26 includes, as functional configurations, a vehicle state acquisition unit 260, a position acquisition unit 261, a shape recognition unit 262, and a detection processing unit 263.

The vehicle state acquisition unit 260 is arranged to receive various signals from, e.g., the vehicle speed sensor 23, a shift position sensor 24, and a steering angle sensor 25 illustrated in FIG. 1 to acquire traveling state information corresponding to a traveling state of an own vehicle 10. The traveling state information contains, for example, a vehicle speed, a steering angle, and a shift position. The traveling state information also contains a case where the own vehicle 10 is stopped, i.e., a case where the vehicle speed is 0 km/h. In the present embodiment, the vehicle state acquisition unit 260 is an interface provided between a CPU and each of various sensors such as the vehicle speed sensor 23, and to the CPU, transmits various signals received from various sensors such as the vehicle speed sensor 23 or signals obtained in such a manner that predetermined processing is performed for these various signals. Note that for the sake of simplicity in illustration, various sensors such as the vehicle speed sensor 23 are not shown in FIG. 2.

In a case where the obstacle sensing device 20 detects the obstacle B positioned on the front side of the own vehicle 10, any adjacent two of a first front sonar SF1, a second front sonar SF2, a third front sonar SF3, and a fourth front sonar SF4 are taken as a first distance measurement sensor and a second distance measurement sensor. On the other hand, in a case where the obstacle sensing device 20 detects the obstacle B positioned on the rear side of the own vehicle 10, the first distance measurement sensor and the second distance measurement sensor are any adjacent two of a first rear sonar SR1, a second rear sonar SR2, a third rear sonar SR3, and a fourth rear sonar SR4.

The position acquisition unit 261 is arranged to acquire relative position information corresponding to a positional relationship between the own vehicle 10 and the obstacle B by triangulation based on the positions of the first distance measurement sensor and the second distance measurement sensor in a case where a reflection wave produced by a search wave transmitted from the first distance measurement sensor being reflected from the obstacle B is received as a reception wave by the first distance measurement sensor and the second distance measurement sensor. That is, the position acquisition unit 261 acquires the relative position information based on the output of each of the multiple distance measurement sensors 21.

The relative position information is information corresponding to the position of the obstacle B relative to the own vehicle 10, which is acquired based on the reception wave of each of the multiple distance measurement sensors 21. The relative position information contains distance information and orientation information. The distance information is information corresponding to the distance of the obstacle B from the own vehicle 10. The orientation information is information corresponding to the orientation of the obstacle B from the own vehicle 10, i.e., an angle between an active line from the own vehicle 10 to the obstacle B and a vehicle center axis line VL.

The shape recognition unit 262 is arranged to execute shape recognition of the obstacle B based on image information acquired by the image capturing unit 22 and the traveling state information acquired by the vehicle state acquisition unit 260. Specifically, in the present embodiment, the shape recognition unit 262 is configured to acquire, based on multiple pieces of the image information acquired in time series in association with movement of the own vehicle 10, three-dimensional positions of multiple feature points of the image information, to recognize the three-dimensional shape of the obstacle B. That is, the shape recognition unit 262 three-dimensionally recognizes, a characteristic shape of an object or the like in an image based on multiple images sequentially captured by the image capturing unit 22 during movement of the vehicle 10.

The characteristic shape includes a straight edge such as a horizontal edge or a vertical edge. The “straight edge” is a continuous pixel row corresponding to an object outline etc. and having a predetermined length or more in an image. The “horizontal edge” indicates a straight edge parallel to a horizontal line in an image. The “vertical edge” indicates a straight edge parallel to a vertical line in an image. The “object outline etc.” includes not only the outline of the obstacle B but also the outline of an indication such as a compartment line.

Specifically, the shape recognition unit 262 is configured to three-dimensionally recognize the characteristic shape by a so-called mobile stereo technique or a SFM technique. SFM stands for structure from motion. The mobile stereo technique and the SFM technique are already publicly known or well-known at the time of filing the present application. Thus, in the present specification, detailed description of the mobile stereo technique and the SFM technique will be omitted.

The detection processing unit 263 is arranged to detect the obstacle B based on the relative position information acquired by the position acquisition unit 261 and a shape recognition result by the shape recognition unit 262. Specifically, in the present embodiment, the detection processing unit 263 is configured to discard the relative position information corresponding to an obstacle B in a case where the shape recognition result by the shape recognition unit 262 indicates that the height dimension of the obstacle B is less than a predetermined dimension.

### (Schematic of Operation)

Hereinafter, the schematic of operation in the obstacle sensing device 20, i.e., the control unit 26, will be described with reference to FIGS. 1 to 6. Note that in operation description below, it is assumed that the own vehicle 10 is moving straight forward and not all units are shown in the figure to avoid complicated illustration and description.

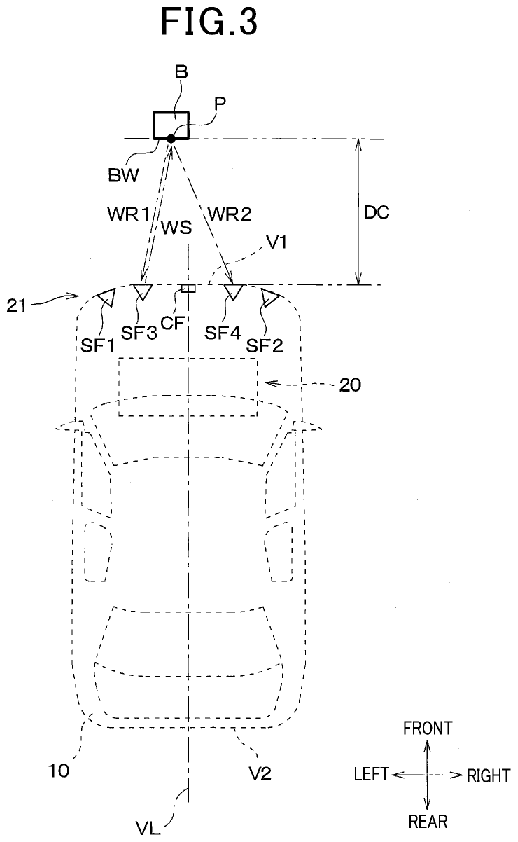

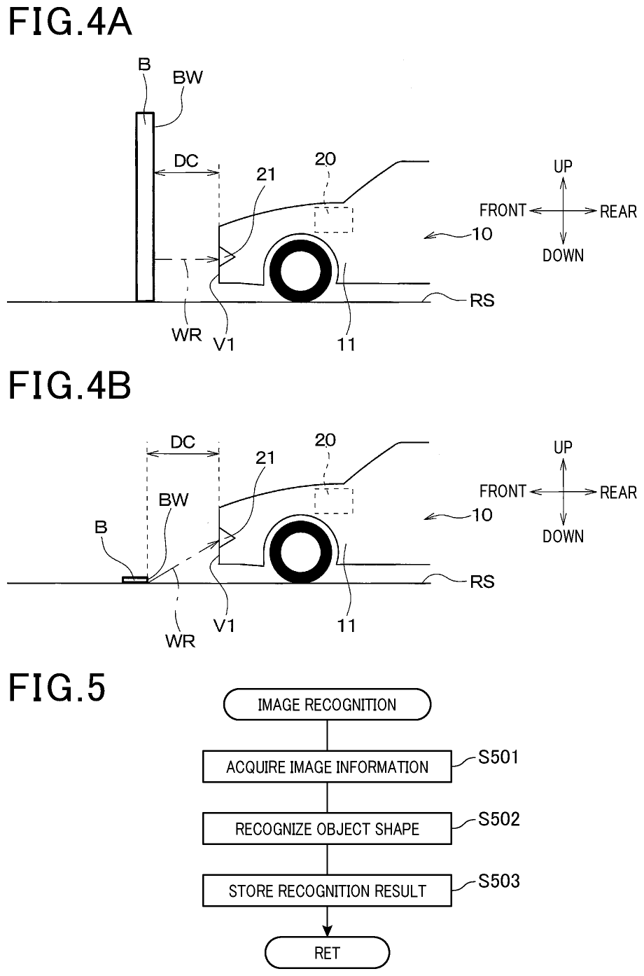

FIGS. 3, 4A, and 4B illustrate a state in which the own vehicle 10 senses the obstacle B present on the front side. As illustrated in FIG. 3, the obstacle sensing device 20 detects the obstacle B present on the front side by means of the first front sonar SF1, the second front sonar SF2, the third front sonar SF3, and the fourth front sonar SF4. Moreover, the obstacle sensing device 20 recognizes the three-dimensional shape of the obstacle B present on the front side by means of a front camera CF.

Note that in a case where the own vehicle 10 moves backward, the obstacle sensing device 20 detects the obstacle B present on the rear side by means of the first rear sonar SR1, the second rear sonar SR2, the third rear sonar SR3, and the fourth rear sonar SR4. Moreover, the obstacle sensing device 20 recognizes the three-dimensional shape of the obstacle B present on the rear side by means of a rear camera CB. Obstacle sensing operation upon backward movement is basically similar to that upon forward movement. Thus, the schematic of operation of the obstacle sensing device 20 will be hereinafter described using the obstacle sensing operation upon forward movement as an example.

FIG. 3 illustrates a case where the obstacle B is positioned between the third front sonar SF3 and the fourth front sonar SF4 in the vehicle width direction. In this case, a reflection wave produced by a search wave WS transmitted from the third front sonar SF3 or the fourth front sonar SF4 being reflected on a wall surface BW of the obstacle B is received by the third front sonar SF3 and the fourth front sonar SF4, and therefore, the relative position of the obstacle B relative to the own vehicle 10 is acquired. Hereinafter, description of the schematic of operation will be continued assuming that the search wave WS is transmitted from the third front sonar SF3, a reception wave WR1 corresponding to the search wave WS is received by the third front sonar SF3, and a reception wave WR2 corresponding to the search wave WS is received by the fourth front sonar SF4.

The reception wave WR1 as a direct wave for the third front sonar SF3 is received by the third front sonar SF3 in such a manner that the search wave WS transmitted from the third front sonar SF3 is reflected on the wall surface BW of the obstacle B. Meanwhile, the reception wave WR2 as an indirect wave for the fourth front sonar SF4 is received by the fourth front sonar SF4 in such a manner that the search wave WS transmitted from the third front sonar SF3 is reflected on the wall surface BW of the obstacle B.

Suppose that required time from the point of time of transmission of the search wave WS from the third front sonar SF3 to the point of time of reception of the reception wave WR1 by the third front sonar SF3 is T1. Suppose that required time from the point of time of transmission of the search wave WS from the third front sonar SF3 to the point of time of reception of the reception wave WR2 by the fourth front sonar SF4 is T2. Suppose that the speed of sound is c. In this case, when a distance from the third front sonar SF3 to the wall surface BW of the obstacle B along a propagation direction of the reception wave WR1 is D1, D1=0.5T1×c is satisfied. Moreover, when a distance from the fourth front sonar SF4 to the wall surface BW of the obstacle B along a propagation direction of the reception wave WR2 is D2, D2=(T2−0.5T1)×c is satisfied.

When a point, which is assumed as a reflection point of the search wave WS, on the wall surface BW of the obstacle B, is defined as a “detection point P,” D1 is a distance from the third front sonar SF3 to the detection point P, and D2 is a distance from the fourth front sonar SF4 to the detection point P. The horizontal positions of the third front sonar SF3 and the fourth front sonar SF4 at the own vehicle 10 are constant. Thus, the position of the detection point P relative to the own vehicle 10 is acquired by triangulation using the horizontal positions of the third front sonar SF3 and the fourth front sonar SF4 and the calculated distances D1, D2.

A travelable distance DC while the own vehicle 10 is traveling forward is a horizontal distance from a front surface V1 to the detection point P in a traveling direction of the own vehicle 10. As illustrated in FIG. 3, in a case where the own vehicle 10 is traveling straight ahead, the travelable distance DC is a distance from the front surface V1 to the detection point P in the front-to-rear direction. Note that the travelable distance DC is the minimum in a case where the own vehicle 10 travels straight ahead. Thus, considering, e.g., processing load reduction, it is allowed to assume that the travelable distance DC while the own vehicle 10 is traveling forward is the distance from the front surface V1 to the detection point P in the front-to-rear direction regardless of the steering angle.

FIG. 4A illustrates a state in which the own vehicle 10 is traveling toward the obstacle B with a great height dimension. FIG. 4B illustrates a state in which the own vehicle 10 is traveling toward the obstacle B with a small height dimension. The obstacle B with the great height dimension as illustrated in FIG. 4A is a wall or the like, for example. The obstacle B with the small height dimension as illustrated in FIG. 4B, i.e., the obstacle B with a short protrusion height from a road surface RS, is a step or a curbstone or the like, for example.

Note that in the present embodiment, the height dimension of the obstacle B corresponds to the protrusion height of the obstacle B from the road surface RS, i.e., the protrusion length of the obstacle B from the road surface RS in the vehicle height direction. Such a height dimension of the obstacle B may be also referred to as a distance between a base end portion and a tip end portion of the obstacle B in the vehicle height direction. In examples of FIGS. 4A and 4B, the base end portion corresponds to a lower end portion, and the tip end portion corresponds to an upper end portion.

In FIGS. 4A and 4B, an arrow indicating the travelable distance DC is a horizontal distance between the own vehicle 10 and the obstacle B, and is the shortest distance between the own vehicle 10 and the obstacle B in plan view. A direction defining the travelable distance DC is parallel to the road surface RS. Note that the vehicle height direction, i.e., the up-to-down direction, might not be parallel to the gravity acting direction depending on an inclination state of the road surface RS in some cases.

The distance measurement sensor 21 is attached to a vehicle body 11. The vehicle body 11 is positioned above the road surface RS. Thus, the mounting height of the distance measurement sensor 21, i.e., the mounting position of the distance measurement sensor 21 in the vehicle height direction, is the distance of the distance measurement sensor 21 from the road surface RS in the vehicle height direction.

Hereinafter, the mounting height of the distance measurement sensor 21 will be referred to as a “sensor mounting height.” The sensor mounting height is a predetermined value according to the distance of the vehicle body 11 from the road surface RS and the mounting position of the distance measurement sensor 21 at the vehicle body 11. Specifically, the sensor mounting height is the height of the mounting position of the distance measurement sensor 21 from the road surface RS in a case where the own vehicle 10 is mounted on the road surface RS parallel to a horizontal plane.

As illustrated in FIG. 4A, in the case of the obstacle B with a greater height dimension than the sensor mounting height, the wall surface BW of the obstacle B is present at the same height as that of the distance measurement sensor 21. Thus, a reception wave WR reaching the distance measurement sensor 21 propagates parallel to a direction defining the horizontal distance. Thus, in this case, the distance information from the obstacle B acquired by means of the distance measurement sensor 21 may be substantially accurate information corresponding to an actual horizontal distance between the own vehicle 10 and the obstacle B, i.e., the travelable distance DC.

On the other hand, in the case of the obstacle B with a smaller height dimension than the sensor mounting height as illustrated in FIG. 4B, the upper end portion of the obstacle B is at a position lower than the distance measurement sensor 21. That is, the wall surface BW of the obstacle B is not present at the same height as that of the distance measurement sensor 21. In this case, the reception wave WR reaching the distance measurement sensor 21 propagates diagonally upward from the lower end portion of the obstacle B to the distance measurement sensor 21. Thus, in the case of the obstacle B with the smaller height dimension than the sensor mounting height, the distance information from the obstacle B acquired by means of the distance measurement sensor 21 is inaccurate information containing a great error.

Moreover, there is a case where the obstacle B with the smaller height dimension than the sensor mounting height as described above is an object with such a small protrusion height that the own vehicle 10 can directly pass over the object. Examples of such an object include a low step with a height of about 5 cm and a lid of a manhole. Such an obstacle B does not interfere with traveling of the own vehicle 10 at all, and therefore, the need for recognizing the obstacle B as an “obstacle” in drive assist operation is low.

For this reason, in the present embodiment, in a case where the shape recognition result obtained by means of the front camera CF indicates that the height dimension of the obstacle B is equal to or greater than the predetermined dimension, the obstacle sensing device 20 validates the relative position information corresponding to such an obstacle B and stores the information in a non-volatile RAM. On the other hand, in a case where the shape recognition result obtained by means of the front camera CF indicates that the height dimension of the obstacle B is less than the predetermined dimension, the obstacle sensing device 20 invalidates the relative position information corresponding to such an obstacle B and discards the information.

With this configuration, e.g., unnecessary informing operation due to recognition of the object with such a small protrusion height that the own vehicle 10 can directly move over the object without interference with traveling of the own vehicle 10 as the obstacle B can be suppressed as much as possible. The above-described “predetermined height” for suppressing this type of erroneous object recognition may be set to about 5 to 10 cm, for example.

### (Operation Examples)

Hereinafter, specific operation examples, which correspond to the above-described schematic of operation, by the configuration of the present embodiment will be described with reference to flowcharts. Note that in description in the drawings and the specification, a “step” will be merely abbreviated as “S.”

FIG. 5 is a flowchart of one example of shape recognition operation of the obstacle B based on the image information acquired by the image capturing unit 22. An image recognition routine illustrated in FIG. 5 corresponds to operation of the shape recognition unit 262. This image recognition routine is also similarly executed in later-described second to fourth embodiments. This image recognition routine is activated by the CPU at predetermined time intervals after a predetermination activation condition has been satisfied.

When the image recognition routine illustrated in FIG. 5 is activated, the CPU first acquires the image information from the image capturing unit 22 at 5501. Moreover, the CPU stores the acquired image information in time series in the non-volatile RAM.

Next, at S502, the CPU executes the image recognition operation by the shape recognition unit 262 by means of the mobile stereo technique or the SFM technique. Accordingly, the three-dimensional shape of an object or the like in an image is recognized. Specifically, e.g., the height of the obstacle B can be recognized. Subsequently, at S503, the CPU stores the image recognition result by the shape recognition unit 262 in the non-volatile RAM, and the present routine ends temporarily.

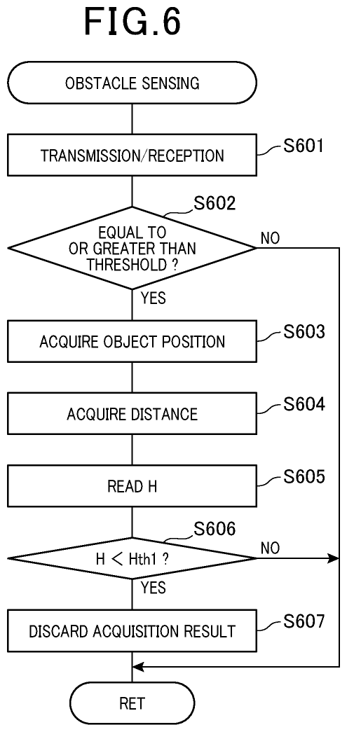

FIG. 6 is a flowchart of one example of the operation of sensing the obstacle B based on the relative position information acquired by two adjacent distance measurement sensors 21 and the image information acquired by the image capturing unit 22. An obstacle sensing routine illustrated in FIG. 6 corresponds to operation of the position acquisition unit 261 and the detection processing unit 263. This obstacle sensing routine is also similarly executed in the later-described second and third embodiments. This obstacle sensing routine is activated at predetermined time intervals by the CPU after a predetermined activation condition has been satisfied.

When the obstacle sensing routine illustrated in FIG. 6 is activated, the CPU first selects, at S601, two adjacent distance measurement sensors 21 to acquire reception information from the selected two distance measurement sensors 21. In the above-described example, two adjacent distance measurement sensors 21 are the third front sonar SF3 and the fourth front sonar SF4. That is, at S601, the search wave is transmitted from the third front sonar SF3, and the reception wave is received by the third front sonar SF3 and the fourth front sonar SF4.

Next, at S602, the CPU determines whether any of the reception wave intensities of two adjacent distance measurement sensors 21 is equal to or greater than a predetermined threshold. In a case where a condition where any of the reception wave intensities of two adjacent distance measurement sensors 21 is equal to or greater than the predetermined threshold is not satisfied (i.e., S602=NO), the above-described triangulation is not satisfied. Thus, in this case, the CPU skips all types of processing after S603, and the present routine ends temporarily.

Hereinafter, description of the present routine will be continued assuming that the condition where any of the reception wave intensities of two adjacent distance measurement sensors 21 is equal to or greater than the predetermined threshold is satisfied (i.e., S602=YES). In this case, the CPU proceeds the processing to a step after S603.

At S603, the CPU acquires the relative position information on the obstacle B based on the acquired reception information. In the above-described example, the CPU acquires, at S603, the detection point P corresponding to the obstacle B. Next, at S604, the CPU acquires the distance to the obstacle B. In the above-described example, the CPU acquires the travelable distance DC at S604. The relative position information and the travelable distance DC acquired at S603 and S604 are temporarily stored in the non-volatile RAM.

Subsequently, the CPU acquires, at S605, the height H of the obstacle B corresponding to the reception wave with an intensity of equal to or higher than the threshold based on the image recognition result stored in the non-volatile RAM. Moreover, at S606, the CPU determines whether the height H acquired at S605 is less than a predetermined height Hth1. The predetermined height Hth1 is 5 cm, for example.

In a case where the height H is less than the predetermined height Hth1 (i.e., S606=YES), the CPU proceeds the processing to S607, and thereafter, the present routine ends temporarily. At S607, the CPU invalidates and discards the relative position information and the travelable distance DC currently acquired at S603 and S604, respectively. That is, the CPU deletes a record of the relative position information and the travelable distance DC, which are currently acquired at S603 and S604 respectively, in the non-volatile RAM.

On the other hand, in a case where the height H is equal to or greater than the predetermined height Hth1 (i.e., S606=NO), the CPU skips the processing of S607, and the present routine ends temporarily. In this case, the relative position information and the travelable distance DC regarding the obstacle B corresponding to the reception wave with an intensity of equal to or higher than the threshold and having a height dimension of equal to or greater than the predetermined height Hth1 are used for the drive assist operation of the own vehicle 10.

### Second Embodiment

Hereinafter, an obstacle sensing device 20 of the second embodiment will be described. In description of the second embodiment below, differences from the above-described first embodiment will be mainly described. Moreover, the same reference numerals are used to represent identical or equivalent elements in the second embodiment and the above-described first embodiment. Thus, in description of the second embodiment below, description in the first embodiment above may be, as long as there are no technical inconsistencies or additional exceptional description, used as reference regarding components with the same reference numerals as those of the above-described first embodiment, as necessary. The same applies to a third embodiment described later.

A configuration of the present embodiment is similar to the configuration of the above-described first embodiment. The present embodiment corresponds to the operation of sensing an obstacle B by means of a first side sonar SS1, a second side sonar SS2, a third side sonar SS3, and a fourth side sonar SS4.

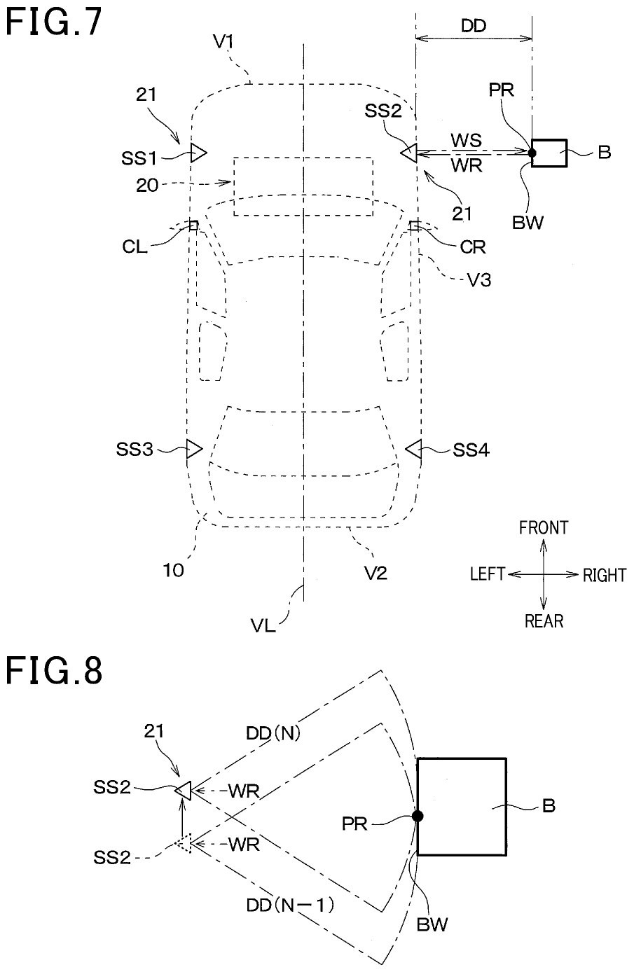

Referring to FIG. 7, the first side sonar SS1, the second side sonar SS2, the third side sonar SS3, and the fourth side sonar SS4 output signals corresponding to a distance to the obstacle B positioned at the side of an own vehicle 10. Moreover, a left camera CL and a right camera CR acquire image information corresponding to side images of the own vehicle 10. These cameras are used for, parking space detection or the like when the obstacle sensing device 20 is used for drive assist operation.

As described above, each of the first side sonar SS1, the second side sonar SS2, the third side sonar SS3, and the fourth side sonar SS4 can detect the distance to the opposing obstacle B by a direct wave. Moreover, the obstacle sensing device 20 can recognize the shape of the obstacle B positioned at the side of the own vehicle 10 by means of the first side sonar SS1, the second side sonar SS2, the third side sonar SS3, and the fourth side sonar SS4.

FIG. 7 illustrates, by way of example, a case where the obstacle B is present on the right side of the second side sonar SS2 and the right camera CR. Hereinafter, the schematic of the operation of sensing the obstacle B positioned on the right side of the own vehicle 10 will be described with reference to the example of FIG. 7.

As illustrated in FIG. 7, the second side sonar SS2 receives, as a reception wave WR, a reflection wave produced by a search wave WS transmitted from the second side sonar SS2 itself being reflected from the obstacle B, and therefore, outputs a signal corresponding to the distance to such an obstacle B. The obstacle sensing device 20 repeatedly acquires a distance DD to the obstacle B based on the reception wave WR repeatedly received at predetermined time intervals by the second side sonar SS2 during traveling of the own vehicle 10. The predetermined time interval is several hundreds of milliseconds, for example. Moreover, the obstacle sensing device 20 acquires a sonar position, i.e., the position of the second side sonar SS2 corresponding to each of multiple distances DD, based on traveling state information on the own vehicle 10 and the time of transmission of the search wave WS or the time of reception of the reception wave WR.

The obstacle sensing device 20 can schematically estimate the outer shape of the obstacle B in plan view based on the multiple distances DD acquired as described above and the sonar position corresponding to each of these multiple distances DD. For example, the obstacle sensing device 20 recognizes the multiple distances DD as a point sequence on two-dimensional coordinates taking the sonar position as the horizontal axis and taking the distance DD as the vertical axis. The obstacle sensing device 20 executes predetermined processing based on triangulation for such a point sequence, thereby estimating a reflection point PR corresponding to each of the multiple distances DD.

The reflection point PR is a position estimated as a reflection position of the reception wave WR on the obstacle B. That is, the reflection point PR is a virtual position on the obstacle B, the virtual position corresponding to the distance DD acquired by single reception of the reception wave WR. The outer shape of the obstacle B in plan view is schematically estimated by a point sequence including multiple reflection points PR. The reflection point PR is a point estimated as a point on a wall surface BW of the obstacle B, the point facing the own vehicle 10. The reflection point PR corresponds to relative position information on the obstacle B.

Note that estimation of the outer shape of the obstacle B in plan view by means of the direct wave as described above has been already publicly known at the time of filing the present application. For example, see U.S. Pat. No. 7,739,046, U.S. Pat. No. 7,843,767, and U.S. Pat. No. 8,130,120 and the like.

Alternatively, the obstacle sensing device 20 can acquire the reflection point PR by triangulation based on the sonar position for the second side sonar SS2 and the distance DD acquired at different points of time during traveling of the own vehicle 10. FIG. 8 schematically illustrates such an example of acquisition of the reflection point PR.

That is, the position of the second side sonar SS2 indicated by a solid line indicates, referring to FIG. 8, the position of the second side sonar SS2 at the time of current reception of the reception wave WR. On the other hand, the position of the second side sonar SS2 indicated by a dashed line indicates the position of the second side sonar SS2 at the time of previous reception of the reception wave WR. The current reception is assumed to be an N-th reception, and the previous reception is assumed to be an N-1-th reception. Moreover, the previously-acquired distance DD is assumed to be DD(N-1), and the currently-acquired distance DD is assumed to be DD(N).

A time interval between the time of acquisition of the previous distance DD(N-1) and the time of acquisition of the current distance DD(N) is sufficiently short as described above. Thus, it can be assumed that the position of the wall surface BW having reflected the search wave corresponding to the distance DD(N-1) and the position of the wall surface BW having reflected the search wave corresponding to the distance DD(N) are the same as each other. Thus, the obstacle sensing device 20 acquires, as the reflection point PR, an intersection between a first circle whose radius about the position of the second side sonar SS2 at the point of time of acquisition of the distance DD(N-1) is the distance DD(N-1) and a second circle whose radius about the position of the second side sonar SS2 at the point of time of acquisition of the distance DD(N) is the distance DD(N).

As described above, the obstacle sensing device 20 can acquire the relative position information on the obstacle B positioned at the side of the own vehicle 10 and the schematic shape of the obstacle B in plan view, by means of the first side sonar SS1, the second side sonar SS2, the third side sonar SS3, and the fourth side sonar SS4. However, the height of the obstacle B is unknown.

Meanwhile, the obstacle sensing device 20 can acquire the height of the obstacle B by means of the left camera CL and the right camera CR. Specifically, as illustrated in FIG. 7, in a case where the obstacle B is present on the right side of the own vehicle 10, the obstacle sensing device 20 can acquire the height of the obstacle B by means of the right camera CR. That is, the obstacle sensing device 20 can recognize, for example, the height of the obstacle B by the above-described image processing technique such as the mobile stereo technique or the SFM technique.

FIG. 7 illustrates a situation where the obstacle sensing device 20 searches a parking space on the right side of the own vehicle 10. In this situation, the obstacle B might be, in some cases, an object with such a small protrusion height that the own vehicle 10 can directly move over the object. Examples of this type of object include a low step with a height of about 5 cm and a lid of a manhole and the like.

In this case, such an obstacle B is not substantially an obstacle in the drive assist operation. That is, a region including such an obstacle B can be set as the parking space. Moreover, such an obstacle B is allowed to be present on a parking path to the parking space. Thus, the relative position information corresponding to such an obstacle B does not need to be held.

Thus, in a case where a shape recognition result obtained by means of the left camera CL and the right camera CR indicates that the height dimension of the obstacle B is equal to or greater than a predetermined dimension, the obstacle sensing device 20 validates the relative position information corresponding to such an obstacle B, and stores the information in a non-volatile RAM. On the other hand, in a case where the shape recognition result obtained by means of the left camera CL and the right camera CR indicates that the height dimension of the obstacle B is less than the predetermined dimension, the obstacle sensing device 20 invalidates and discards the relative position information corresponding to such an obstacle B. According to the present embodiment, more appropriate parking assist operation can be implemented, and a calculation load in a CPU and a storage capacity in the non-volatile RAM can be reduced.

### Third Embodiment

Hereinafter, an obstacle sensing device 20 of the third embodiment will be described. In description of the third embodiment below, differences from the above-described first embodiment will be mainly described.

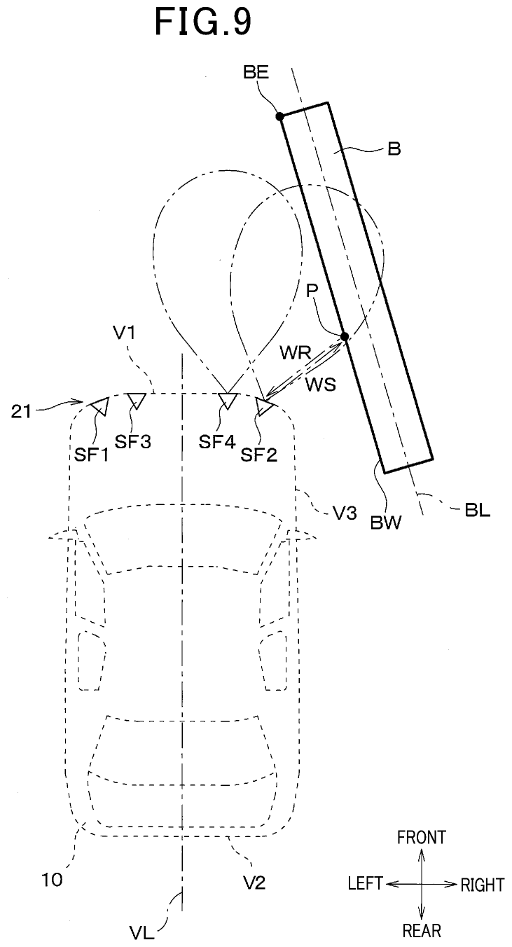

A configuration of the present embodiment is similar to the configuration of the above-described first embodiment. As illustrated in FIG. 9, the present embodiment corresponds to the operation of sensing a wall-shaped obstacle B standing inclined with respect to a vehicle center axis line VL in a case where an own vehicle 10 is traveling while approaching the obstacle B. The obstacle B in this case will be hereinafter referred to as an “inclined wall.”

Note that for the sake of simplicity in description, it is assumed that the own vehicle 10 is traveling straight forward and the obstacle B as the inclined wall is present on the front right side of the own vehicle 10 in an example of FIG. 9. Moreover, detectable areas of a second front sonar SF2 and a fourth front sonar SF4 are indicated by chain double-dashed lines in the figure.

In the example of FIG. 9, an object center axis BL of the inclined wall crosses the vehicle center axis line VL. In plan view, the object center axis BL is the center axis of the obstacle B along the vehicle traveling direction. In this example, the object center axis BL is, in plan view, parallel to a wall surface BW of the obstacle B facing the own vehicle 10.

As illustrated in FIG. 9, an angle between the object center axis BL and the vehicle center axis line VL might be, in some cases, decreased such that the obstacle B as the inclined wall is present only in the detectable area of the second front sonar SF2. In this case, a direct wave for the second front sonar SF2 can be received, but on the other hand, an indirect wave for the second front sonar SF2 and the fourth front sonar SF4 cannot be received. That is, in this case, triangulation by the second front sonar SF2 and the fourth front sonar SF4 is not possible.

In the example illustrated in FIG. 9, relative position information corresponding to the obstacle B is acquired based on the direct wave for the second front sonar SF2. Such a direct wave is a reception wave WR received by the second front sonar SF2 and resulting from a reflection wave produced by a search wave WS transmitted from the second front sonar SF2 being reflected from the obstacle B.

Specifically, the obstacle sensing device 20 may estimate, as a detection point P, the rightmost position of the detectable area of the second front sonar SF2 in plan view, for example. Alternatively, the obstacle sensing device 20 may estimate, as the detection point P, the position of the search wave WS on the center axis, for example. Alternatively, as in the above-described second embodiment, the obstacle sensing device 20 may estimate, for example, the detection point P based on the positions of the second front sonar SF2 and detected distances for the second front sonar SF2 at different points of time.

Such relative position information is not acquired based on a first indirect wave which is the reception wave received by the second front sonar SF2 and which results from a search wave transmitted from the fourth front sonar SF4 and reflected from the obstacle B. Moreover, such relative position information is not acquired based on a second indirect wave which is a reception wave received by the fourth front sonar SF4 and which results from a reflection wave produced by the search wave transmitted from the second front sonar SF2 being reflected from the obstacle B. Thus, such relative position information will be hereinafter expressed as one “based only on the direct wave for the second front sonar SF2.”

There is a probability that the detected distance itself to the wall surface BW of the obstacle B based only on the direct wave for the second front sonar SF2 is not utilized for drive assist of the own vehicle 10. Note that relative position information on an end portion BE of the obstacle B as the inclined wall in the traveling direction can be estimated based on a shape recognition result based on image information acquired by a front camera CF and the detected distance based only on the direct wave for the second front sonar SF2. Thus, even when the shape recognition result based on the image information acquired by an image capturing unit 22 indicates that the height dimension of the obstacle B is equal to or greater than a predetermined dimension, if the detection point P is based only on the direct wave for the second front sonar SF2, the obstacle sensing device 20 recognizes that the obstacle B is the inclined wall.

In the present embodiment, the second front sonar SF2 and the fourth front sonar SF4 are provided at a front portion 12 as a surface of the own vehicle 10 on a traveling direction side. Moreover, the obstacle sensing device 20, i.e., a detection processing unit 263 illustrated in FIG. 2, recognizes the obstacle B as the inclined wall in a case where the shape recognition result obtained by means of the front camera CF indicates that the height dimension of the obstacle B is equal to or greater than the predetermined dimension and the acquired relative position information is based only on the direct wave for the second front sonar SF2. Such an inclined wall has the wall surface BW crossing the vehicle center axis line VL of the own vehicle 10, and has a possibility that the wall surface BW approaches the own vehicle 10 in association with traveling of the own vehicle 10.

In a case where the obstacle B is recognized as the inclined wall, the obstacle sensing device 20 executes predetermined processing. For example, as in the above-described first embodiment, the predetermined processing is the processing of invalidating and discarding the relative position information corresponding to the obstacle B. Alternatively, the predetermined processing is, for example, the processing of informing a driver of the own vehicle 10 of the presence of the inclined wall on the front side by a display 27 and the like. Alternatively, the predetermined processing is, for example, for searching a straight edge passing the vicinity of the detection point P and extending forward on the basis of the shape recognition result based on the image information, forming an extension line along the straight edge from the detection point P, and estimating the relative position of a vertical edge crossing the extension line as the relative position of the end portion BE.

### (Operation Example)

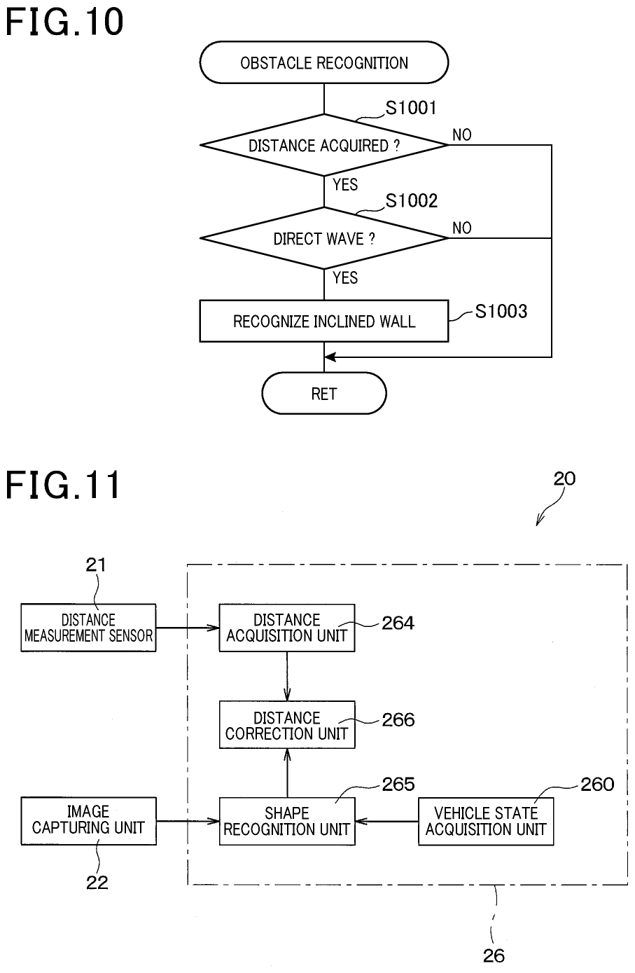

FIG. 10 is a flowchart of a specific operation example corresponding to the present embodiment. An obstacle recognition routine illustrated in FIG. 10 is activated by a CPU at predetermined time intervals after a predetermined activation condition has been satisfied. Note that as a precondition for activating the obstacle recognition routine illustrated in FIG. 10, it is assumed that an image recognition routine illustrated in FIG. 5 and an obstacle sensing routine illustrated in FIG. 6 have been already executed.

Further, in the present embodiment, the determination contents of S602 in the obstacle sensing routine illustrated in FIG. 6 are determination on whether the reception wave intensity of either one of selected two adjacent distance measurement sensors 21 is equal to or higher than a predetermined threshold. That is, in the present embodiment, even in a case where only the direct wave for one of the selected adjacent two distance measurement sensors 21 has an intensity of equal to or higher than the predetermined threshold, the processing of S603 and S604 is executed. Thus, in this case, the relative position information on the obstacle B, which contains a distance to the obstacle B, is also acquired based on the direct wave as described above.

When the obstacle recognition routine illustrated in FIG. 10 is activated, the CPU first determines, at S1001, whether the distance to the obstacle B has been validly acquired. That is, at S1001, the CPU determines, for the obstacle B for which the relative position information has been acquired, whether a height H is equal to or greater than a predetermined height Hth1 and the relative position information has been temporarily validated.

In a case where the distance to the obstacle B is not validly acquired (i.e., S1001=NO), the CPU skips all types of processing after S1002, and the present routine ends temporarily. On the other hand, in a case where the distance to the obstacle B is validly acquired (i.e., S1001=YES), the CPU proceeds the processing to a step after S1002.

At S1002, the CPU determines whether the acquired distance is based only on the direct wave for a first front sonar SF1 or the second front sonar SF2. In a case where the distance to the obstacle B has been acquired based only on the direct wave for the second front sonar SF2, the obstacle B is the inclined wall positioned on the front left side of the own vehicle 10 as illustrated in FIG. 9. On the other hand, in a case where the distance to the obstacle B has been acquired based only on the direct wave for the first front sonar SF1, the obstacle B is the inclined wall positioned on the front left side of the own vehicle 10.

In a case where the acquired distance is based only on the direct wave (i.e., S1002=YES), the CPU proceeds the processing to S1003, and the present routine ends temporarily. At S1003, the CPU recognizes the currently-detected obstacle B as the inclined wall, and executes the predetermined processing as described above. On the other hand, in a case where the acquired distance is based on the indirect wave (i.e., S1002=NO), the CPU skips the processing of S1003, and the present routine ends temporarily.

### Fourth Embodiment

Next, functional block configurations of an obstacle sensing device 20 and a control unit 26 in the fourth embodiment will be described with reference to FIG. 11. In description of the fourth embodiment below, differences from the above-described first embodiment will be mainly described. Note that the configuration of FIG. 1 is common to the first embodiment and the fourth embodiment. Thus, the fourth embodiment will be described below with reference to FIGS. 1 and 3, as necessary.

As illustrated in FIG. 1, the obstacle sensing device 20 of the present embodiment is also mounted on an own vehicle 10 to sense an obstacle B present outside the own vehicle 10. Referring to FIG. 1, the obstacle sensing device 20 of the present embodiment includes a distance measurement sensor 21, an image capturing unit 22, a vehicle speed sensor 23, a shift position sensor 24, a steering angle sensor 25, the control unit 26, and a display 27. The distance measurement sensor 21 and the image capturing unit 22 are similar to those of the above-described first embodiment.

The obstacle sensing device 20 includes at least one distance measurement sensor 21. The control unit 26 is configured to detect the obstacle B based on a reception wave reception result by the distance measurement sensor 21, an image capturing result by the image capturing unit 22, and various signals received from various sensors such as the vehicle speed sensor 23. Specifically, as illustrated in FIG. 11, the control unit 26 includes, as functional configurations, a vehicle state acquisition unit 260, a distance acquisition unit 264, a shape recognition unit 265, and a distance correction unit 266.

The distance acquisition unit 264 is arranged to acquire distance information corresponding to the distance of the obstacle B from the own vehicle 10 based on the output signal of the distance measurement sensor 21. Specifically, as in each of the above-described embodiments, the distance acquisition unit 264 is configured to acquire the distance to the obstacle B.

The shape recognition unit 265 is arranged to execute recognition of the shape of the obstacle B based on image information acquired by the image capturing unit 22. That is, as in the shape recognition unit 262 according to the above-described first embodiment, the shape recognition unit 265 has the function of recognizing the three-dimensional shape of an object from multiple pieces of image information acquired in time series.

The distance correction unit 266 is arranged to correct distance information corresponding to the obstacle B based on a sensor mounting height in a case where a shape recognition result obtained by the shape recognition unit 265 indicates that the height dimension of the obstacle B is less than a predetermined dimension. The above-described “predetermined dimension” may be, for example, set to about 10 to 25 cm as described later.

### (Schematic of Operation)

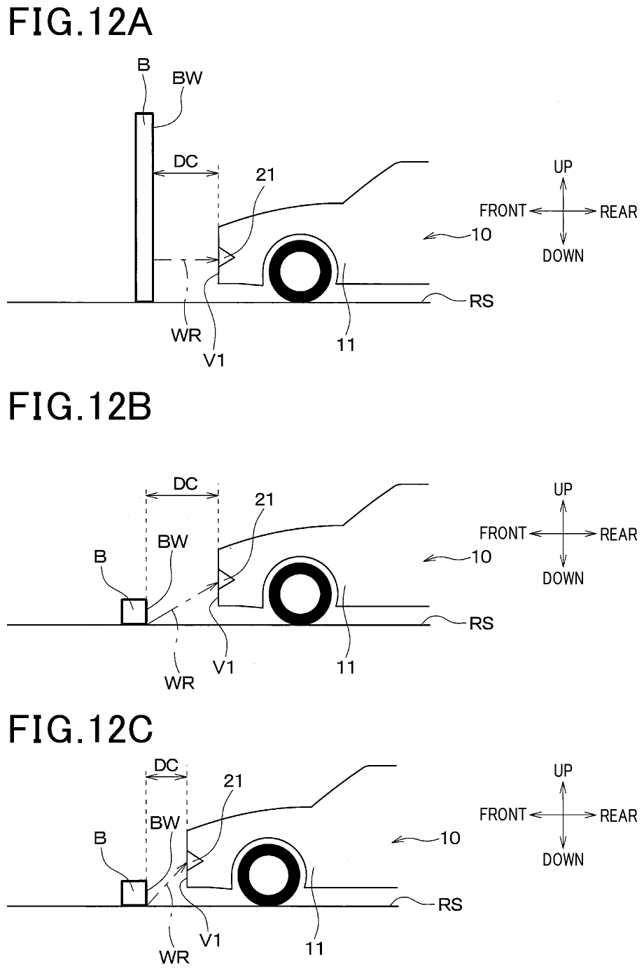

FIG. 12A illustrates a state in which the own vehicle 10 travels toward the obstacle B with a great height dimension, i.e., the obstacle B whose protrusion height from a road surface RS is sufficiently greater than the mounting height of the distance measurement sensor 21.

The obstacle B with the great height dimension as illustrated in FIG. 12A is a wall, for example. As illustrated in FIG. 12A, in a case where the height dimension of the obstacle B is great and a wall surface BW of the obstacle B is present at the same height as that of the distance measurement sensor 21, the distance information for the obstacle B obtained by means of the distance measurement sensor 21 may be substantially accurate information corresponding to an actual horizontal distance between the own vehicle 10 and the obstacle B.

FIGS. 12B and 12C illustrate a state in a case where the height of the obstacle B in FIG. 12A is decreased as compared to the sensor mounting height. The obstacle B with a small height dimension as illustrated in FIGS. 12B and 12C is a step, a car stop, or a curbstone, or the like, for example. FIG. 12C illustrates a state in which the own vehicle 10 approaches the obstacle B more closely than the state illustrated in FIG. 12B.

As illustrated in FIG. 12B, in a case where the height dimension of the obstacle B is small and the wall surface BW of the obstacle B is not present at the same height as that of the distance measurement sensor 21, the distance information for the obstacle B obtained by means of the distance measurement sensor 21 might contain a non-negligible error with respect to the actual horizontal distance between the own vehicle 10 and the obstacle B. Further, as clearly seen from comparison between FIG. 12B and FIG. 12C, a shorter actual horizontal distance of the obstacle B from the own vehicle 10 results in a greater error in the distance information.

For this reason, in the present embodiment, the distance correction unit 266 corrects the distance to the obstacle B, which has been acquired by the distance acquisition unit 264, in a case where the shape recognition result obtained by the shape recognition unit 265 indicates that the height dimension of the obstacle B is less than the predetermined dimension. Accordingly, the relative position of the obstacle B with a short protrusion height from the road surface RS relative to the own vehicle 10 can be more accurately recognized. Examples of this type of obstacle B include a car stop and a curbstone and the like. Thus, the above-described “predetermined height” for correcting the distance information on this type of obstacle B may be set to about 10 to 25 cm, for example.

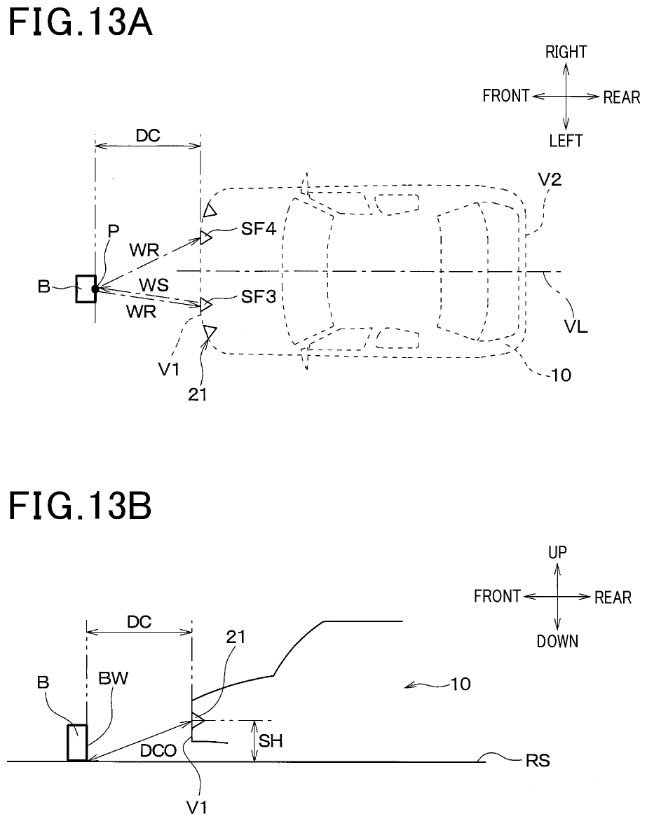

FIGS. 13A and 13B illustrate the schematic of distance correction by the distance correction unit 266. Note that in this example, it is assumed that the obstacle B is positioned between a third front sonar SF3 and a fourth front sonar SF4 in the vehicle width direction. Hereinafter, the schematic of acquisition and correction of a detected distance will be described with reference to an example of FIGS. 13A and 13B.

The distance acquisition unit 264 acquires, by triangulation using the third front sonar SF3 and the fourth front sonar SF4, a horizontal distance from an end surface of the own vehicle 10 equipped with the distance measurement sensor 21 facing the obstacle B to the obstacle B. In this example, the end surface of the own vehicle 10 is a front surface V1 of a front bumper 13. The acquired horizontal distance is a travelable distance DC.

If the height of an upper end portion of the obstacle B is sufficiently greater than the sensor mounting heights of the third front sonar SF3 and the fourth front sonar SF4 as illustrated in FIG. 12A, the travelable distance DC acquired by the distance acquisition unit 264 is an accurate horizontal distance. On the other hand, in a case where the height of the upper end portion of the obstacle B is less than the sensor mounting heights as illustrated in FIG. 13B, the travelable distance acquired by the distance acquisition unit 264 is not an accurate horizontal distance, and is a distance DC0 in a diagonal direction in a side view. This DC0 will be referred to as a “pre-correction distance.”

The pre-correction distance DC0 corresponds to an oblique side of a right-angled triangle whose bottom side is a length corresponding to a post-correction travelable distance DC needing to be acquired and whose height is SH. SH is a distance between a base end portion position of the obstacle B and a sensor mounting position of the third front sonar SF3 and the fourth front sonar SF4 in the vehicle height direction. SH may be equal to the sensor mounting height. In a case where the shape recognition result obtained by the shape recognition unit 265 indicates that the height dimension of the obstacle B is less than the predetermined dimension, the distance correction unit 266 corrects the acquired horizontal distance, i.e., the travelable distance DC. That is, the distance correction unit 266 can calculate the post-correction travelable distance DC by a mathematical expression DC=(DC0²−SH²)^{1/2}.

### (Operation Example)

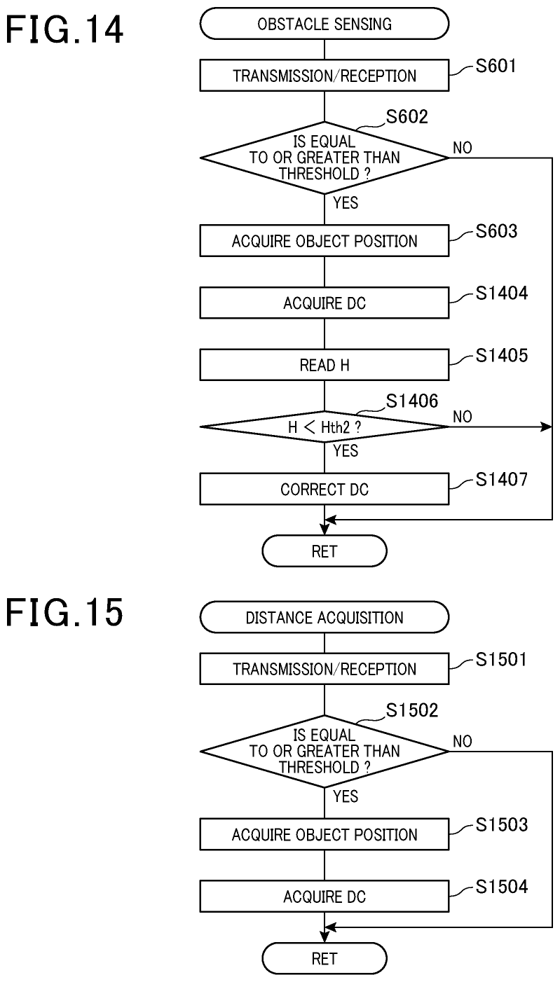

FIG. 14 is a flowchart of a specific operation example corresponding to the present embodiment. An obstacle sensing routine illustrated in FIG. 14 is activated by a CPU at predetermined time intervals after a predetermined activation condition has been satisfied. Note that as a precondition for activating the obstacle recognition routine illustrated in FIG. 14, it is assumed that an image recognition routine illustrated in FIG. 5 has been already executed. That is, the obstacle sensing routine illustrated in FIG. 14 is configured such that part of an obstacle sensing routine illustrated in FIG. 6 is changed.

The obstacle sensing routine illustrated in FIG. 14 is activated by the CPU at the predetermined time intervals after the predetermined activation condition has been satisfied. In the obstacle sensing routine illustrated in FIG. 14, S601 to S603 are the same as processing in the obstacle sensing routine illustrated in FIG. 6. Thus, description of S601 to S603 will be omitted.

After the processing of S603, the CPU executes the processing of S1404. At S1404, the CPU acquires the travelable distance DC. Note that in a case where determination at S1406 described later is YES and correction processing at S1407 is executed, the travelable distance DC acquired at S1404 corresponds to the above-described pre-correction distance DC0.

After the processing of S1404, the CPU executes the processing of S1405. At S1405, the CPU acquires the height H of the obstacle B corresponding to a reception wave with an intensity of equal to or higher than a threshold based on an image recognition result stored in a non-volatile RAM. That is, the processing contents of S1405 are the same as the processing of S605 in the obstacle sensing routine illustrated in FIG. 6.

After the processing of S1405, the CPU executes the processing of S1406. At S1406, the CPU determines whether the height H acquired at S1405 is less than a predetermined height Hth2. The predetermined height Hth2 is 20 cm, for example. That is, the processing in the present embodiment is for correcting the travelable distance DC in a case where the obstacle B has a smaller height dimension than the sensor mounting height but that the own vehicle 10 cannot move over the obstacle B. Thus, the predetermined height Hth2 as a threshold for determination at S1406 is set considering the sensor mounting height, and is normally a greater value than a threshold Hth1 at S606.

In a case where the height H acquired at S1405 is less than the predetermined height Hth2 (i.e., S1406=YES), the CPU executes the processing of S1407, and thereafter, the present routine ends temporarily. At S1407, the CPU takes the travelable distance acquired at S1404 as the pre-correction distance DC0 to calculate the post-correction travelable distance DC according to the mathematical expression DC=(DC0²−SH²)^{1/2}. On the other hand, in a case where the height H acquired at S1405 is equal to or greater than the predetermined height Hth2 (i.e., S1406=NO), the CPU skips the processing of S1407, and the present routine ends temporarily.

### Fifth Embodiment

Next, an obstacle sensing device 20 of a fifth embodiment will be described. The present embodiment corresponds to a form in which an image recognition processing load is reduced as compared to the fourth embodiment using the mobile stereo technique or the SFM technique.

A functional block configuration of the present embodiment is similar to that of the fourth embodiment. Thus, the configuration of the present embodiment may be described with reference to FIGS. 1 and 11 and description regarding these figures, as necessary. Moreover, the schematic of operation of the present embodiment may be described with reference to FIGS. 12A to 13B and description regarding these figures, as necessary. In description of the fifth embodiment below, differences from the above-described fourth embodiment will be also mainly described.

A shape recognition unit 265 is arranged to execute recognition of the shape of an obstacle B based on image information acquired by an image capturing unit 22. Note that in the present embodiment, the shape recognition unit 265 has, unlike the first to fourth embodiments, the function of extracting a characteristic shape of an object from image information corresponding to a single image and the function of recognizing a pattern on a texture image.

That is, the shape recognition unit 265 extracts a straight edge corresponding to distance information acquired by a distance acquisition unit 264. Moreover, the shape recognition unit 265 recognizes the obstacle B corresponding to the above-described straight edge based on a texture image of the periphery of the extracted straight edge. Specifically, the shape recognition unit 265 compares texture images in two image regions adjacent to each other sandwiching a single straight edge, thereby recognizing whether the obstacle B corresponding to the above-described straight edge is a step with a small height dimension. Hereinafter, such a step will be referred to as a “low step.”

As described above, in the present embodiment, the shape recognition unit 265 can easily determine, based on the image information acquired by the image capturing unit 22, whether the obstacle B is the low step. In a case where the shape recognition unit 265 has recognized that the obstacle B is the low step, a distance correction unit 266 corrects the distance information corresponding to such an obstacle B. Correction of the distance information is similar to that of the above-described fourth embodiment.

### (Operation Example)

FIGS. 15 to 17 are flowcharts of a specific operation example corresponding to the present embodiment. A distance acquisition routine illustrated in FIG. 15 corresponds to operation of the distance acquisition unit 264. This distance acquisition routine is activated by a CPU at predetermined time intervals after a predetermined activation condition has been satisfied.

When the distance acquisition routine illustrated in FIG. 15 is activated, the CPU first selects, at S1501, two adjacent distance measurement sensors 21, and acquires reception information from the selected two distance measurement sensors 21. Next, at S1502, the CPU determines whether any of the reception wave intensities of the two adjacent distance measurement sensors 21 is equal to or higher than a predetermined threshold.

In a case where a condition where any of the reception wave intensities of the two adjacent distance measurement sensors 21 is equal to or higher than the predetermined threshold is not satisfied (i.e., S1502=NO), the above-described triangulation is not impossible. Thus, in this case, the CPU skips the processing of S1503 and S1504, and the present routine ends temporarily. On the other hand, in a case where the condition where any of the reception wave intensities of the two adjacent distance measurement sensors 21 is equal to or higher than the predetermined threshold is satisfied (i.e., S1502=YES), the CPU executes the processing of S1503 and S1504, and thereafter, the present routine ends temporarily.

At S1503, the CPU acquires relative position information on the obstacle B based on the acquired reception information. Specifically, the CPU acquires a detection point P corresponding to the obstacle B as illustrated in FIG. 13A. Next, at S1504, the CPU acquires the distance information corresponding to the obstacle B. That is, at S1504, the CPU acquires a travelable distance DC. Moreover, the CPU stores acquisition results at S1503 and S1504 in a non-volatile RAM.

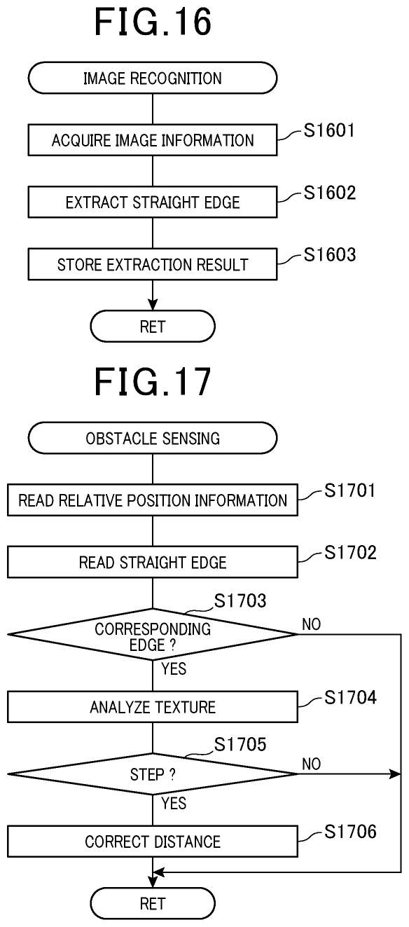

An image recognition routine illustrated in FIG. 16 corresponds to part of operation of the shape recognition unit 265. This image recognition routine is activated by the CPU at predetermined time intervals after a predetermined activation condition has been satisfied.

When the image recognition routine illustrated in FIG. 16 is activated, the CPU first acquires, at S1601, the image information from the image capturing unit 22. Moreover, the CPU stores the acquired image information in the non-volatile RAM. Next, at S1602, the CPU extracts the characteristic shape such as the straight edge and the pattern on the texture image from the stored image information. Subsequently, at S1603, the CPU stores an extraction result at S1602 in the non-volatile RAM, and the present routine ends temporarily.

An obstacle sensing routine illustrated in FIG. 17 corresponds to part of operation of the shape recognition unit 265 and operation of the distance correction unit 266. This obstacle sensing routine is activated by the CPU at predetermined time intervals after a predetermined activation condition has been satisfied.

When the obstacle sensing routine illustrated in FIG. 17 is activated, the CPU first reads, at S1701, the relative position information acquired by execution of the distance acquisition routine illustrated in FIG. 15 from the non-volatile RAM. Accordingly, a two-dimensional map of the detection point P obtained by the distance measurement sensor 21 is acquired. Next, at S1702, the CPU reads the straight edge acquired by execution of the image recognition routine illustrated in FIG. 16 from the non-volatile RAM.

Subsequently, at S1703, the CPU determines whether the straight edge corresponding to the detection point P is present. In a case where the straight edge corresponding to the detection point P is not present (i.e., S1703=NO), the CPU skips all of processing after S1704, and the present routine ends temporarily. On the other hand, in a case where the straight edge corresponding to the detection point P is present (i.e., S1703=YES), the CPU proceeds the processing to S1704 and S1705.

At S1704, the CPU compares the texture images in the two image regions adjacent to each other sandwiching the straight edge, thereby recognizing whether the obstacle B corresponding to the straight edge is the low step. Specifically, in a case where the textures in the two image regions adjacent to each other sandwiching the straight edge are coincident with each other, the CPU recognizes the obstacle B as the low step. On the other hand, in a case where the textures in the two image regions adjacent to each other sandwiching the straight edge are not coincident with each other, the CPU recognizes that the obstacle B is a three-dimensional object with a greater height dimension than that of the low step.

At S1705, the CPU determines whether a recognition result of the obstacle B indicates the low step. In a case where the recognition result of the obstacle B indicates the low step (i.e., S1705=YES), the CPU executes the processing of S1706, and thereafter, the present routine ends temporarily. At S1706, the CPU takes, as in the above-described fourth embodiment, the travelable distance acquired at S1504 as a pre-correction distance DC0, thereby calculating a post-correction travelable distance DC according to DC=(DC0²−SH2)^{1/2}. In a case where the recognition result of the obstacle B indicates the three-dimensional object with the greater height dimension (i.e., S1705=NO), the CPU skips the processing of S1706, and the present routine ends temporarily.

### (Advantageous Effects)

As in a typical technique, the sensing result of the obstacle B based on the relative position information acquired by the distance measurement sensor 21 is directly susceptible to the height dimension of the obstacle B. Note that as in JP-A-2014-58247 described above, when an attempt is made to acquire the height dimension of the obstacle B based on the sensing result itself obtained by the distance measurement sensor 21, the error increases. This is because the basic function of the distance measurement sensor 21 is for outputting the signal corresponding to the distance to the obstacle B and such output does not essentially contain the information regarding the height of the obstacle B.

On the other hand, according to the image recognition result based on the image information acquired by the image capturing unit 22, the information on the height direction of the obstacle B can be obtained. Thus, in each of the above-described embodiments, the obstacle sensing device 20 integrates the sensing result of the obstacle B based on the relative position information acquired by the distance measurement sensor 21 and the image recognition result based on the image information acquired by the image capturing unit 22, thereby sensing the obstacle B. With this configuration, sensing of the obstacle B present outside the own vehicle 10 can be more properly performed.

### (Modifications)

The present disclosure is not limited to each of the above-described embodiments. Thus, changes can be made to the above-described embodiments, as necessary. Hereinafter, representative modifications will be described. In description of the modifications below, differences from the above-described embodiments will be mainly described.

The present disclosure is not limited to the specific device configuration described in each of the above-described embodiments. That is, the own vehicle 10 is not limited to the four-wheeled vehicle, for example. Specifically, the own vehicle 10 may be a three-wheeled vehicle or a six-wheeled or eight-wheeled vehicle such as a cargo truck. Moreover, the type of own vehicle 10 may be a vehicle including only an internal combustion engine, an electric vehicle or a fuel cell vehicle including no internal combustion engine, or a hybrid vehicle. The shape of the vehicle body 11 is also not limited to a box shape, i.e., the substantially rectangular shape in plan view. The number of door panels 17 is not also specifically limited.

Arrangement of the distance measurement sensor 21 and the number of distance measurement sensors 21 in a case where the distance measurement sensor 21 is the ultrasonic sensor are not limited to those of the above-described specific examples. That is, referring to, e.g., FIG. 1, in a case where the third front sonar SF3 is arranged at the center position in the vehicle width direction, the fourth front sonar SF4 is omitted. Similarly, in a case where the third rear sonar SR3 is arranged at the center position in the vehicle width direction, the fourth rear sonar SR4 is omitted. The third side sonar SS3 and the fourth side sonar SS4 may be omitted.

The distance measurement sensor 21 is not limited to the ultrasonic sensor. That is, the distance measurement sensor 21 may be, for example, a laser radar sensor or a millimeter wave radar sensor. Similarly, the image sensor forming the image capturing unit 22 is not limited to the CCD sensor. That is, instead of the CCD sensor, a CMOS sensor may be used, for example. CMOS stands for complementary MOS.

Arrangement of the image capturing unit 22 and the number of image capturing units 22 are not limited to those of the above-described examples. That is, the front camera CF may be arranged in the vehicle compartment, for example. Specifically, the front camera CF may be, for example, attached to a room mirror in the vehicle compartment. The front camera CF may be one or two. That is, the obstacle sensing device 20 may have a pantoscopic stereo camera configuration. For example, the left camera CL and the right camera CR may be arranged at positions different from those of the door mirrors 18. Alternatively, the left camera CL and the right camera CR may be omitted.

In each of the above-described embodiments, the control unit 26 is configured such that the CPU reads the program from the ROM or the like and activates the program. However, the present disclosure is not limited to such a configuration. That is, the control unit 26 may be a digital circuit capable of performing the above-described operation, for example, an ASIC such as a gate array. ASIC stands for an application specific integrated circuit.

The present disclosure is not limited to the specific operation examples and the specific processing forms described in the above-described embodiments. For example, a location for storing the recognition result may be other storage media than the non-volatile RAM, such as a RAM and/or a magnetic storage medium.

In the above-described specific examples, the processing when forward movement of the own vehicle 10 has been mainly described. However, the present disclosure is also preferably applicable to backward movement of the own vehicle 10. That is, processing contents upon backward movement are essentially similar to the above-described processing contents upon forward movement, except that the distance measurement sensor 21 and the image capturing unit 22 provided on a rear portion 14 side of the own vehicle 10 are used.

The processing contents in the shape recognition unit 262 are not limited to those of the above-described examples. That is, pantoscopic stereo processing or integrated processing of SFM and pantoscopic stereo may be used, for example. The pantoscopic stereo processing or the integrated processing of SFM and pantoscopic stereo has been already publicly known or well-known at the time of filing the present application. For example, see JP-A-2007-263657 and JP-A-2007-263669.

Upon invalidation of the relative position information and the travelable distance DC at S607, such invalidated data is not necessarily discarded. That is, invalidation of the relative position information and the travelable distance DC at S607 may be, for example, the processing of storing, in the non-volatile RAM, the relative position information and the travelable distance DC currently acquired at S603 and S604 while also storing information indicating invalidation of such data in the non-volatile RAM.

Before determination at S1406, determination at S606 may be executed. In such a modification, the CPU determines, prior to determination at S1406, whether the height H acquired at S1405 is less than the predetermined height Hth1.

In this modification, in a case where the height H is less than the predetermined height Hth1, the CPU executes the processing of S607. That is, the acquisition results of the relative position information and the travelable distance DC are invalidated. Thereafter, the routine ends temporarily. On the other hand, in a case where the height H is equal to or greater than the predetermined height Hth1, the CPU proceeds the processing to S1406. That is, in a case where the height of the obstacle B is equal to or greater than Hth1 and less than Hth2, the CPU corrects the travelable distance DC by the processing of S1407.

The predetermined height Hth1 and the predetermined height Hth2 may be the same value.

Correction of the travelable distance DC at S1407 or the like is not limited to calculation using the above-described mathematical expression. Specifically, correction of the travelable distance DC may be performed as follows, for example.

As described above, a shorter actual horizontal distance of the obstacle B from the own vehicle 10 results in a greater error in the distance information. Moreover, a smaller value of the height H results in a greater error in the distance information.

Thus, a correction value map DC_AMD (DC, H) using, as parameters, the value of the travelable distance DC acquired at S1404 and the value of height H acquired at S1405 may be produced in advance by an adaptability test or the like. Moreover, predetermined arithmetic processing is performed using a correction value DC_AMD acquired using this correction value map and the value of the pre-correction travelable distance DC acquired at S1404, and therefore, the post-correction travelable distance DC can be acquired. Specifically, the correction value DC_AMD and the value of the pre-correction travelable distance DC acquired at S1404 may be subjected to addition or integration, for example.

There might be a situation where the obstacle B in FIGS. 4A, 4B, 12A, 12B, and 12C is arranged above the road surface RS, such as a wall extending downward from a ceiling or a shutter gate movable up and down. In this situation, a space is formed between the obstacle B and the road surface RS. Such a space will be hereinafter referred to as a “lower space.”

In the case of applying each of the above-described examples to this situation, the height H acquired at S605 is, for example, the height of the above-described lower space, i.e., the height of the horizontal edge corresponding to the lower end of the obstacle B from the road surface RS. Moreover, determination at S606 is, for example, determination on whether the height H of the lower space is equal to or less than a predetermined height Hth3.

In a case where the height H of the lower space exceeds the predetermined height Hth3, the lower end of the obstacle B is too higher than the sensor mounting height, and therefore, a detected distance error similar to that described above occurs. For this reason, in this case, the travelable distance DC is corrected. On the other hand, in a case where the height H of the lower space is equal to or less than the predetermined height Hth3, the wall surface BW of the obstacle B favorably faces the distance measurement sensor 21. Thus, in this case, the travelable distance DC is not corrected.

For example, depending on the height of the own vehicle 10 equipped with the obstacle sensing device 20, the own vehicle 10 might not be able to pass through the lower space of the wall extending downward from the ceiling. Alternatively, the own vehicle 10 equipped with the obstacle sensing device 20 might not be able to pass below the obstacle B as the out-of-order shutter gate stopped in the middle of upward movement, for example. On this point, according to the present modification, the distance between the obstacle B and the own vehicle 10 impossible to pass through the lower space of the obstacle B in these cases can be more accurately acquired.

Note that there might be a situation where the obstacle B in FIG. 4A etc. is a beam protruding downward from the ceiling. In this situation, the own vehicle 10 does not come into contact with such an obstacle B. Thus, it is not necessary to correct the relative position information and the travelable distance DC corresponding to such an obstacle B, and it is allowed to invalidate the relative position information and the travelable distance DC. Thus, in a case where the height H of the lower space exceeds a predetermined height Hth4, the CPU may execute invalidation processing similar to that of S607.

The CPU may distinguish a correction processing form between a case where the obstacle B protrudes upward from the road surface RS and a case where the obstacle B extends downward from the ceiling. That is, in a case where the obstacle B protrudes upward from the road surface RS, the correction processing form is similar to that of FIG. 14 (i.e., S1406 and S1407). On the other hand, in a case where the obstacle B extends downward from the ceiling, S1406 is the determination processing of “H>Hth3?” Moreover, after this determination processing, the determination processing of “H>Hth4?” may be performed as necessary.

Distinguishing according to a case as described above may be performed by the CPU based on an image processing result. That is, the CPU may determine, based on the image processing result, whether the obstacle B corresponding to the extracted horizontal edge is one protruding upward from the road surface RS or one extending downward from the ceiling.

Predetermined values may be, as the predetermined heights Hth3, Hth4, stored in advance in the ROM or the non-volatile RAM. Alternatively, the predetermined height Hth3 may be changed according to the height of the own vehicle 10 equipped with the obstacle sensing device 20. That is, in the obstacle sensing device 20, the value of the predetermined height Hth3 corresponding to the height of the own vehicle 10 on which the obstacle sensing device 20 is mounted may be rewritably stored in the non-volatile RAM. Rewriting of the predetermined height Hth3 may be performed by a manufacturer, a seller, a manager, or a user of the own vehicle 10 or the obstacle sensing device 20, as necessary.

“Acquisition” may be changed to similar expressions such as “estimation,” “detection,” “sensing,” “calculation,” etc., as necessary. An inequality sign in each type of determination processing may be with or without an equal sign. That is, “less than a predetermined dimension” may be changed to “equal to or less than the predetermined dimension,” for example. Similarly, “equal to or greater than a predetermined dimension” may be changed to “exceed the predetermined dimension.” Similarly, “less than a predetermined height” may be changed to “equal to or less than the predetermined height.” Similarly, “equal to or greater than a threshold” may be changed to “exceed the threshold.”

The modifications are not limited to the above-described examples. Moreover, multiple modifications may be combined together. Further, the above-described embodiments may be combined together.

What is claimed is:

1. An obstacle sensing device mounted on an own vehicle to sense an obstacle present outside the own vehicle, comprising:
at least one distance measurement sensor that is arranged to transmit a search wave toward the outside of the own vehicle and receive a reception wave containing a reflection wave produced by the search wave being reflected from the obstacle to output a signal corresponding to a distance to the obstacle;
an image capturing unit that is arranged to acquire image information corresponding to an image of a periphery of the own vehicle;
a vehicle state acquisition unit that is arranged to acquire traveling state information corresponding to a traveling state of the own vehicle;
a position acquisition unit that is arranged to acquire, based on the output signal of the distance measurement sensor, relative position information corresponding to a relative position of the obstacle relative to the own vehicle;
a shape recognition unit that is arranged to execute shape recognition of the obstacle based on the image information acquired by the image capturing unit and the traveling state information acquired by the vehicle state acquisition unit; and
a detection processing unit that is arranged to detect the obstacle based on the relative position information acquired by the position acquisition unit and a shape recognition result obtained by the shape recognition unit,
wherein the detection processing unit is configured to discard the relative position information corresponding to the obstacle in a case where the shape recognition result indicates that a height dimension of the obstacle is less than a predetermined dimension.

2. The obstacle sensing device according to claim 1, wherein
the at least one distance measurement sensor includes first and second distance measurement sensors provided at different positions,
the first distance measurement sensor and the second distance measurement sensor are provided in such a positional relationship that the reflection wave produced by the search wave sent from any one of the first and second distance measurement sensors being reflected from the obstacle is able to be received as the reception wave for the other of the first and second distance measurement sensors, and
the position acquisition unit is arranged to acquire the relative position information by triangulation based on respective positions of the first and second distance measurement sensors in a case where the reflection wave produced by the search wave sent from the first distance measurement sensor being reflected from the obstacle is received, as the reception wave, by the first distance measurement sensor and the second distance measurement sensor.

3. The obstacle sensing device according to claim 2, wherein
the first distance measurement sensor and the second distance measurement sensor are provided at a traveling direction side surface of the own vehicle,
in a case where
the shape recognition result indicates that the height dimension of the obstacle is equal to or greater than the predetermined dimension, and
the relative position information corresponding to the obstacle is acquired:
not based on a first indirect wave which is the reception wave received by the first distance measurement sensor and which results from the reflection wave produced by the search wave transmitted from the second distance measurement sensor being reflected from the obstacle,
not based on a second indirect wave which is the reception wave received by the second distance measurement sensor and which results from the reflection wave produced by the search wave transmitted from the first distance measurement sensor being reflected from the obstacle, but
based on a direct wave which is the reception wave received by the first distance measurement sensor and which results from the reflection wave produced by the search wave transmitted from the first distance measurement sensor being reflected from the obstacle,
the detection processing unit recognizes that the obstacle has a wall surface that is inclined with respect to a vehicle center axis line of the own vehicle and there is a probability that the wall surface approaches the own vehicle in association with traveling of the own vehicle.

4. The obstacle sensing device according to claim 1, wherein
the distance measurement sensor is provided to receive, as the reception wave, the reflection wave produced by the search wave sent from the distance measurement sensor itself being reflected from the obstacle to output the signal corresponding to the distance to the obstacle, and
the position acquisition unit is arranged to acquire the relative position information by triangulation based on a position of the distance measurement sensor and the distance to the obstacle, the position and the distance being acquired at different points of time during traveling of the own vehicle.

5. The obstacle sensing device according to claim 1, wherein
the shape recognition unit is arranged to acquire three-dimensional positions of multiple feature points on the image information based on the traveling state information acquired by the vehicle state acquisition unit and multiple pieces of the image information acquired in time series in association with movement of the own vehicle by the image capturing unit, thereby recognizing a three-dimensional shape of the obstacle.

6. An obstacle sensing device mounted on an own vehicle to detect an obstacle present outside the own vehicle, comprising:
at least one distance measurement sensor that is arranged to transmit a search wave toward the outside of the own vehicle and receive a reception wave containing a reflection wave produced by the search wave being reflected from the obstacle to output a signal corresponding to a distance to the obstacle;
an image capturing unit that is arranged to acquire image information corresponding to an image of a periphery of the own vehicle;
a distance acquisition unit that is arranged to acquire distance information corresponding to the distance of the obstacle from the own vehicle based on the output signal of the distance measurement sensor;
a shape recognition unit that is arranged to execute shape recognition of the obstacle based on the image information acquired by the image capturing unit; and
a distance correction unit that is arranged to correct the distance information corresponding to the obstacle based on a mounting position of the distance measurement sensor in a vehicle height direction in a case where a shape recognition result obtained by the shape recognition unit indicates that a height dimension of the obstacle is less than a predetermined dimension.

7. The obstacle sensing device according to claim 6, wherein
the distance acquisition unit is arranged to acquire a horizontal distance from an end surface of the own vehicle equipped with the distance measurement sensor to the obstacle, and
in a case where the shape recognition result indicates that the height dimension of the obstacle is less than the predetermined dimension,
the distance correction unit is arranged to correct the horizontal distance according to an expression below:
DC=(DC0²−SH2)^{1/2}
where DC0 is the horizontal distance acquired by the distance acquisition unit before correction by the distance correction unit, DC is the horizontal distance after correction by the distance correction unit, and SH is a distance in the vehicle height direction between a base end portion position of the obstacle in the vehicle height direction and the mounting position.

8. The obstacle sensing device according to claim 7, wherein
the at least one distance measurement sensor includes first and second distance measurement sensors provided at different positions at a traveling side end surface as the end surface of the own vehicle positioned on an own vehicle traveling direction side,
the first distance measurement sensor and the second distance measurement sensor are provided in such a positional relationship that the reflection wave produced by the search wave sent from any one of the first and second distance measurement sensors being reflected from the obstacle is able to be received as the reception wave for the other of the first and second measurement sensors,
the distance acquisition unit is arranged to acquire, as the horizontal distance, a travelable distance as a distance in a traveling direction from the traveling side end surface to the obstacle, by triangulation based on positions of the first and second distance measurement sensors in a case where the reflection wave produced by the search wave sent from the first distance measurement sensor being reflected from the obstacle is, as the reception wave, received by the first distance measurement sensor and the second distance measurement sensor, and
the distance correction unit is arranged to correct the travelable distance in a case where the shape recognition result obtained by the shape recognition unit indicates that the height dimension of the obstacle is less than the predetermined dimension.

9. The obstacle sensing device according to claim 6, further comprising:
a vehicle state acquisition unit that is arranged to acquire traveling state information corresponding to a traveling state of the own vehicle,
wherein the shape recognition unit is arranged to acquire three-dimensional positions of multiple feature points on the image information based on the traveling state information acquired by the vehicle state acquisition unit and multiple pieces of the image information acquired in time series in association with movement of the own vehicle by the image capturing unit, thereby recognizing a three-dimensional shape of the obstacle.

10. The obstacle sensing device according to claim 6, wherein
the shape recognition unit is arranged to
extract, from the image information, a straight edge corresponding to the distance information acquired by the distance acquisition unit, and
recognize, based on a texture image of a periphery of the straight edge, whether the obstacle is a step having a height dimension of less than the predetermined dimension,
the distance correction unit is arranged to correct the distance information corresponding to the obstacle in a case where the shape recognition unit recognizes that the obstacle is the step.

11. The obstacle sensing device according to claim 1, wherein
the height dimension is a protrusion height of the obstacle from a road surface.

12. The obstacle sensing device according to claim 1, wherein
the distance measurement sensor is an ultrasonic sensor.
